(19) United States
(12) Patent Application Publication
(10) Pub. No.: US 2024/0232644 A1
(43) Pub. Date: Jul. 11, 2024

(54) APPARATUSES, SYSTEMS, AND METHODS FOR ACTIVE PREDICTIVE CODING NETWORKS

(71) Applicant: University of Washington, Seattle, WA (US)

(72) Inventors: Rajesh P.N. Rao, Seattle, WA (US); Dimitrios C. Gklezakos, Seattle, WA (US); Vishwas Sathish, Seattle, WA (US)

(21) Appl. No.: 18/408,173

(22) Filed: Jan. 9, 2024

Related U.S. Application Data
(60) Provisional application No. 63/479,528, filed on Jan. 11, 2023.

(51) Int. Cl. G06N 3/096; G06N 3/045

(52) U.S. Cl. CPC G06N 3/096; G06N 3/045

(57) ABSTRACT

An active predictive coding network (APCN) is a multi-level network which may break down larger problems into constituent parts. APCNs solve problems compositionally by composing solutions using sequences of previously learned solutions to sub-problems. Considering a pair of adjacent levels, the higher level network includes a state vector and an action vector as well as a state network and action network. At a higher-level ‘macrostep’ the state network updates the state vector and the action network updates the action vector and lower-level state and action networks are generated (or updated) based on the updated state and action vectors respectively. For a number of lower-level ‘microsteps’ the lower-level state network updates a lower-level state vector and the lower-level action network updates a lower-level action vector. The higher-level network may be updated based on the operation of the lower-level network.

### CROSS REFERENCE TO RELATED APPLICATION(S)

This application claims the benefit under 35 U.S.C. § 119 of the earlier filing date of U.S. Provisional Application Ser. No. 63/479,528 filed Jan. 11, 2023, the entire contents of which are hereby incorporated by reference in their entirety for any purpose.

### FEDERALLY SPONSORED RESEARCH AND DEVELOPMENT

This invention was made with government support under Grant No. HR001120C0021, awarded by the Defense Advanced Research Projects Agency. The government has certain rights in the invention.

### BACKGROUND

There is a growing interest in machine learning models, such as neural networks. Neural networks are a useful tool which may be trained to a wide variety of applications. For example, the neural network may be trained based on a set of training data, and based on that training the neural network may adapt itself to a trained task, for example by changing the connection weights between neurons in the network. While a powerful tool, current “deep” neural networks such as convolutional networks have limitations. These networks do not preserve positional or other transformational information about extracted features. They are unable to explain the images they classify in the way humans do: in terms of objects, their locations in a scene, the parts of an object and the locations of these parts within the object, etc. This lack of interpretability of neural networks has prompted a search for alternate models that are inspired by how humans represent objects in terms of part-whole hierarchies and use compositionality of parts to explain new objects. Beyond image processing, the use of neural networks for solving other problems in artificial intelligence (AI), such as language modeling, planning actions and learning policies in reinforcement learning, suffer from the same shortcomings of limited interpretability and compositionality (the ability to compose solutions to complex problems using solutions to simpler sub-problems, and doing this recursively).

Predictive coding has received increasing attention in recent years as a model of how the brain learns models of the world through prediction and self-supervised learning. In predictive coding, feedback connections from a higher to a lower level of a cortical neural network (e.g., the visual cortex) convey predictions of lower-level responses, and the prediction errors are conveyed via feedforward connections to correct the higher-level estimates, completing a prediction-error-correction cycle. Such a model has provided explanations for a wide variety of neural and cognitive phenomena. The layered architecture of the cortex is remarkably similar across cortical areas, hinting at a common computational principle, with superficial layers receiving and processing sensory information and deeper layers conveying outputs to motor centers. The traditional predictive coding model focused on learning visual hierarchical representations and did not acknowledge the important role of actions in learning world models.

Given the shortcomings of traditional neural network and predictive coding models, there is a need for a scalable framework that solves the following problem: how can neural networks learn intrinsic references frames for objects and parse visual scenes into part-whole hierarchies by dynamically allocating nodes in a parse tree? More generally, how can neural networks learn state-action abstraction hierarchies that allow compositional solutions to problems ranging from vision to hierarchical planning and reinforcement learning?

### SUMMARY

In at least one aspect, the present disclosure relates to a method of generating and using an active predictive coding network (APCN) which is implemented on at least one computing device. The method includes inputting a representation of an object, environment or problem to the APCN and initializing a higher-level state vector based on a first frame of reference which represents all or a part of the object, environment or problem, iteratively performing one or more macrosteps to sub-divide the first frame of reference into portions (e.g., second frames of reference) and iteratively performing one or more microsteps on the selected second frame of reference. Performing each macrostep includes updating the higher-level state vector using a higher-level state neural network trained to determine a current state of the first frame of reference, updating a higher-level action vector with a higher-level action neural network trained to select a second frame of reference which is a selected portion of the first frame of reference, where the higher-level action vector indicates the selected second frame of reference, generating or updating a lower-level state neural network with a first trained hypernetwork by providing the updated higher-level state vector as an input to the first trained hypernetwork, and generating or updating a lower-level action neural network with a second trained hypernetwork by providing the updated higher-level action vector as an input to the second trained hypernetwork. Performing each of the microsteps includes updating a lower-level state vector with the lower-level state neural network, wherein the lower-level state neural network is trained to determine a current state of the selected second frame of reference, updating a lower-level action vector with the lower-level action neural network, wherein the lower-level action neural network is trained to analyze or perform an action with respect to the current state of the selected second frame of reference. The APCN assembles a solution with respect to the first frame of reference based on solutions determined with respect to the one or more selected second frames of reference.

The APCN may be trained to receive an image which includes one or more objects as an input and output a classification or reconstruction of the object based on the updated higher-level state vector at the end of the one or more macrosteps where the APCN learns a part-whole hierarchy of the one or more objects. The higher-level state vector may represent the APCN's current estimation or reconstruction of the object, the higher-level action neural network may be trained to select the second frame of reference by selecting a portion of the image including a selected portion of the object, the lower-level state vector may represent the APCN's current estimate of the selected portion of the image, the lower-level action neural network may be trained to select sub-regions within the second frame of reference used to update the estimation of the selected portion, and the higher-level state vector may be updated based on the lower-level state vector at the end of performing the one or more microsteps. The method may include extracting a portion of the image with a glimpse sensor based on a location contained in the higher-level action vector and updating the higher-level state vector based, in part, on the extracted portion.

The APCN may be trained to receive an input which includes information about an environment or problem, a starting location or state of an agent, and a goal state and output a set of instructions which navigate the agent through the environment or problem to the goal state based on the higher-level action vector. The higher-level state vector may represent the environment or problem, starting location or starting state, and the goal, the higher-level action neural network may be trained to identify repeating sub-units of the environment or problem, the lower-level state vector ma represent one of the identified sub-units, the lower-level action vector may represent a path for an agent to take through the portion of the environment or problem space, and an overall path through the environment or problem space may be constructed from the paths through the identified sub-units developed from the lower-level action vectors.

The method may include performing a fixed number of microsteps before performing the next macrostep. The method may include performing microsteps until a termination condition is reached before performing the next macrostep. The method may include generating weights and biases of or updating, via embedding inputs, the lower-level state neural network with the first hypernetwork based on the updated higher-level state vector and generating weights and biases of or updating, via embedding inputs, the lower-level action neural network with the second hypernetwork based on the updated higher-level action vector. The higher-level state neural network, the lower-level state neural network, the higher-level action neural network and the lower-level action neural network may be recurrent neural networks (RNNs) or transformer networks.

The method may include updating at least one of the higher-level state vector or the higher-level action vector based on the updated lower-level state vector, the updated lower-level state vector, or combinations thereof at the end of iteratively performing the one or more microsteps. The method may include generating a predicted input with a decoder based on the lower level state vector and the lower-level action vector, determining an actual input based on the lower-level action vector, comparing the predicted input with the actual input to generate an error, and updating the higher-level state vector based on the error.

The method may include updating the higher-level state vector by providing a previous higher-level state vector and a previous higher-level action vector as inputs to the higher-level state neural network and updating the higher-level action vector by providing the updated higher-level state vector and the previous higher-level action vector as inputs to the higher-level action neural network. The method may include initializing the lower-level state vector with an initialization network based on the higher-level state vector at a first of the microsteps and initializing the lower-level action vector with the lower-level action network based on the initialized lower-level state vector at the first of the microsteps.

In at least one aspect, the present disclosure relates to an apparatus which includes a processor and non-transitory media which stores instructions. The instructions, when executed by the processor, cause the apparatus to initialize a higher-level state vector based on a first frame of reference which represents all or a part of an object or environment, iteratively perform one or more macrosteps to sub-divide the first frame of reference into portions (e.g., second frames of reference) and iteratively perform one or more microsteps on the selected second frame of reference. Each of the macrosteps includes updating the higher-level state vector using a higher-level state neural network trained to determine a current state of the first frame of reference, updating a higher-level action vector with a higher-level action neural network trained to select a second frame of reference which is a selected portion of the first frame of reference, where the higher-level action vector indicates the selected second frame of reference, generating or updating a lower-level state neural network with a first trained hypernetwork by providing the updated higher-level state vector as an input to the first trained hypernetwork, generating or updating a lower-level action neural network with a second trained hypernetwork by providing the updated higher-level action vector as an input to the second trained hypernetwork. Each of the microsteps includes updating a lower-level state vector with the lower-level state neural network where the lower-level state neural network is trained to determine a current state of the selected second frame of reference, and updating a lower-level action vector with the lower-level action neural network where the lower-level action neural network is trained to analyze or perform an action with respect to the current state of the selected second frame of reference.

The instructions may further cause the apparatus to, as part of the macrostep, update the higher-level state vector based on the lower-level state vector, update the higher-level action vector based on the lower-level action vector, or combinations thereof. The instructions may further cause the apparatus to initialize the lower-level state vector based on the higher-level state vector at a first of the at least one microsteps and initialize the lower-level action vector based on the initialized lower-level state vector at the first of the at least one microsteps. The instructions may further cause the apparatus to train a state hypernetwork based, in part, on a training data set or data generated from interactions with the environment or problem and train an action hypernetwork based, in part, on a training data set or data generated from interactions with the environment or problem. The instructions may further cause the apparatus to generate or update the lower-level state network with the state hypernetwork and generate or update the lower-level action network with the action hypernetwork.

In at least one aspect, the present disclosure relates to a method of iteratively determining solutions with respect to an object, environment or problem using an APCN implemented on at least one computing system. The method includes determining a current state of the object, environment or problem based on a previous state and a previous action using a higher-level state neural network of the APCN, determining a current action for the object, environment or problem based on the previous action and the current state using a higher-level action neural network of the APCN, selecting a portion or part of the object, environment or problem based on the current action to sub-divide the object, environment or problem space, generating or updating a lower-level state neural network based on the current state and generating or updating a lower-level action neural network based on the higher-level action wherein the lower-level state neural network and the lower-level action neural network operate on the selected portion, and iteratively updating a lower-level state and a lower-level action using the lower-level state neural network and the lower-level action neural network respectively. The updating includes determining the current lower-level state of the selected part or portion based on a previous lower-level state and a previous lower-level action using the lower-level state neural network, determining a current lower-level action for the selected part or portion based on the current lower-level state of the selected one of the one or more parts or portions and the previous lower-level action of the selected one of the one or more part or portions using the lower-level action network, and updating the higher-level state and the higher-level action based on the iteratively updated lower-level state and the iteratively updated lower-level action.

The higher-level state neural network and the higher-level action neural network may generate or modulate the lower-level state network and the lower-level action network respectively using hypernetworks or an embedding network. The object may be an image and the state may represent integrated scene information provided by the lower-level state neural network and the lower-level action neural network and the action may represent which portion of the object should be selected next for examination by the lower-level state neural network and the lower-level action neural network. The object may represent an environment or problem and the action may represent a set of steps to move an agent towards a goal state in the environment or problem space, and the lower level may generates a lower-level state which represents a sub-unit of the environment or problem and a lower-level action which may represent a path through the sub-unit. The lower-level state function and the lower-level action function may execute for a fixed number of steps or until a lower-level goal is reached.

### BRIEF DESCRIPTION OF THE DRAWINGS

FIG. 1 is a block diagram of an Active Predictive Coding Network (APCN) generative module according to some embodiments of the present disclosure.

FIG. 2 is a block diagram of an APCN according to some embodiments of the present disclosure.

FIGS. 3A-3C are block diagrams which show various additional networks or systems which may be used along with an APCN according to some embodiments of the present disclosure.

FIG. 4 is a schematic illustration of a computing system arranged in accordance with examples of the present disclosure.

FIG. 5 is a flow chart of a method of operation of an APCN according to some embodiments of the present disclosure.

FIGS. 6A-6B are images showing reference frames as an example of an operation of an APCN used for visual perception.

FIG. 7 is a block diagram of an example implementation of an APCN for visual perception according to some embodiments of the present disclosure.

FIG. 8 is a sequence of images representing a sequence of operations of an example APCN to perform visual perception of character according to some embodiments of the present disclosure.

FIG. 9 shows block diagrams showing an example hierarchy of a parse tree which may be used by an APCN performing visual perception of a written character according to some embodiments of the present disclosure.

FIG. 10 shows block diagrams depicting an example hierarchy of a parse tree which may be used by an APCN performing visual perception of a garment according to some embodiments of the present disclosure.

FIG. 11 shows images which represent an example of how the learning of a trained APCN may be applied to novel information.

FIG. 12 shows a set of diagrams representing an example maze and how an APCN may apply hierarchical planning to it according to some embodiments of the present disclosure.

FIG. 13 shows a set of diagrams representing an example maze and how an APCN may apply hierarchical planning to it according to some embodiments of the present disclosure.

FIG. 14 shows graphs comparing the performance of an APCN to other types of machine learning in solving the maze of FIG. 13.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

It may be useful to structure a neural network which operates in a manner analogous to the way biological decision making can be abstracted. For example, at a higher level of abstraction, a person may decide to go to work. This in turn may generate lower-level actions such as ‘walk to car’ and ‘drive to work’, each of which may in turn trigger even more lower-level actions such as moving feet, opening the door, etc. It may be useful to structure a machine learning model in a similar manner, such that a network tasked with a higher-level activity is capable of generating lower-level neural networks which sub-divide and manage sub-components of the problem. A solution to the higher-level activity may be assembled from the lower-level solutions. This may allow for more efficient processing of tasks, which may increase the speed at which the task is performed and/or reduce the computing resources required to perform the task. This hierarchical decomposition also allows for faster transfer of knowledge to new tasks through compositionality: the same lower-level actions can be re-used to solve new tasks. For example, sticking the earlier example, solutions developed for the higher-level action of ‘go to work’ such as ‘walk to car’ may apply to different higher-level actions such as going to the grocery store or a restaurant.

The present disclosure is drawn to Active Predictive Coding Networks (APCNs), a class of structured computerized neural networks inspired by the neocortex that addresses the part-whole learning and state-action abstraction problems using hypernetworks and embedding approaches. APCNs may integrate and build upon neural network concepts such as:

Predictive Coding—APCNs build on predictive coding models of cortical function, which emphasize the role of hierarchical prediction and prediction errors in driving learning and inference.

Visual Attention Networks—APCNs extend previous visual attention approaches such as the Recurrent Attention Model (RAM) and Attend-Infer-Repeat (AIR) by learning structured strategies.

Hierarchical Reinforcement Learning—APCNs leverage ideas in hierarchical reinforcement learning by learning abstract macro-actions (“options”) to hierarchically parse an image into parse trees via hypothesis testing and hierarchically plan actions to solve complex problems.

In an example APCN, information from glimpses is organized in a structured, hierarchical way using intrinsic reference frames computed by a hierarchical network; more generally, APCNs offer a solution to hierarchical Partially Observable Markov Decision Process (POMDP) problems: each level of the hierarchical APCN network is composed of a state network and an action network. The state network at each level integrates the information from input samples and implements the state transition model for POMDPs at a particular level of abstraction. The action network at each level is task specific and responsible for planning actions at that level of abstraction. For example, at every hierarchical level, the state network is trained via predictive coding, while the action network is trained either via reinforcement learning (e.g., the REINFORCE algorithm) or via planning.

The present disclosure describes example implementations of active predictive coding networks (APCNs). The APCN is a multi-level structure which generates solutions based on an object, environment or problem. For example, the solution may take the form of one or more actions taken to solve an application specific task related to the object, environment, or problem. The object, problem, or environment may represent data which may or may not relate to a tangible object. For example, the object may be an image file collected by a sensor such as a scanner or a camera. In another example, the object may be data about an abstraction, such as problem space. For example the problem space may be a location in a building or a maze represented within a computer. The state may represent information about all or a portion of the object, while the action may be task specific based on what the APCN has been trained to do. The ACPN is divided into a state system and an action system. The state system maintains a state vector, which includes information about a current state and the action system maintains an action vector, which includes information about the action to be taken. The term vector may be used to represent a quantity which is represented by a sequence of different values. For example, an image (or portion thereof) may be represented as a vector with individual values representing pixel intensity at a certain location (and/or for a certain color/hue if the image is a color image file). The information in the vector and what form it takes may be specific to the application the APCN is trained to perform.

The APCN may be a multi-level system in that a higher level (or upper level) may use a neural network such as a hypernetwork to generate a lower-level neural network. For example, a state hypernetwork may generate a lower-level state neural network based on the higher-level state vector and an action hypernetwork may generate a lower-level action neural network based on the higher-level action vector. At each level the networks may be in horizontal communication and may be used to update the state and action vectors at that level. Those state and action vectors may, in turn be used to further generate a next lower level of state and action functions. The lower-level vectors or errors based on these vectors may feedback to update the higher-level state and action vectors. The higher level may sub-divide the problem into subsets, and the lower-level may generate solutions to those subsets which are combined back into a solution at the higher-level.

In this manner, each level of the multi-level APCN includes a state network and an action network which communicate to generate respective state and action vectors at that level. At each level, the state network determines a current state vector based on a previous state vector and a previous action vector while the action network determines a current action vector based on a previous action vector and a current state vector. The higher-level state and action networks may perform a ‘macrostep’ and update their respective vectors and then generate or update the lower-level networks. The lower-level networks may then perform one or more ‘microsteps’ (within a single ‘macrostep’) before returning control to the higher-level networks, which may iterate and then repeat the process of generating (or updating) the lower-level networks and so forth. The term macrostep may generally be used to refer to an iterative time step performed by a higher-level of the APCN, while the term microstep may generally be used to refer to an iterative time step performed by a lower-level of the APCN. Each of the macro and microsteps may include interaction between the state and action networks of that level to update the respective state and action vectors of that level. In APCNs with more than two levels, the lower-level microstep may act as a macrostep with respect to a next level down, and so forth. In some embodiments, the lower level may iterate for a fixed number of steps before returning control to the next higher level. In some embodiments, other criterion, such as a termination condition, may be used. When control is returned to the higher-level networks, the lower-level state and/or action vectors may be used to update the higher-level networks and/or state/action vectors.

In one example embodiment, an APCN may be trained to reconstruct an object in an image (e.g., to allow the object to be identified or classified). In such an embodiment, the input to the APCN may be the image file, and the state vector may represent information about the contents of a portion of the image, while the action may represent choosing a different portion of the image to examine. For example, the state vector may encode a portion of the input image, while the action vector may include information such as a location and size of the portion. An output is developed based on all the integrated scene information provided by lower-level state and action networks.

The higher-level functions may operate to select a portion of the image, for example, and the lower-level functions may operate to select portions within the portion selected by the higher-level function. In this manner, the APCN may operate to iteratively examine different regions or ‘glimpses’ of the image in order to more efficiently build up an overall identity of the contents of the image. By sub-dividing the problem at the lower level, at each macrostep the higher level examines a portion of the image while the lower level may examine sub-portions of the current portion. This recursive operation may allow the APCN to provide an output which represents its current reconstruction or estimation of the image based on relatively few examined sub-portions. Thus, the examination of sub-portions at the lower level may help reconstruct the contents of the portion, and the reconstruction or estimation of those portions may be used to generate an output which represents the integrated understanding of the image based on the examined portions. In this way the APCN may learn a part-whole hierarchy of the objects in the image.

In another example embodiment, the APCN may be trained to solve a planning task to reach a goal in a problem space. For example to navigate an agent from a starting location a designated point or goal in a map, building, street grid, maze, etc. In such an embodiment, the input to the APCN may be the goal to be reached and at each time step, some sensory information from the environment indicative of the location or state of an agent. The state vector at each level may represent a subsection of the environment, while the action vector may represent movement directions to get the agent from the current position to a position closer to the designated point. The higher-level functions may operate to navigate a larger portion of the maze and the lower-level functions may be generated to navigate sub-sections of the maze. For example, the environment may be sub-divided into repeating sub-sections (sub-problems), which may be solved by composing a sequence of lower-level functions (compositional solution). By splitting the problem into smaller chunks, the overall solution may be more efficiently handled since each repeating sub-section only needs to be solved once. The overall solution may be integrated from the lower-level results by assembling the solved sub-sections back into the overall path from the current position to the goal.

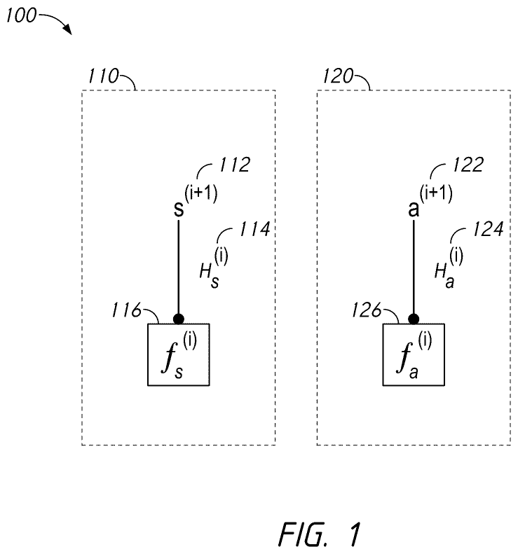

FIG. 1 is a block diagram of an APCN generative module according to some embodiments of the present disclosure. The APCN generative module 100 shows a portion of a larger APCN, and represents the portion which may be used to generate lower level functions. The generative module 100 shows the core sub-unit of an APCN which may be iterated to build a larger APCN structure.

The module is self-similar and is separated into two distinct systems: the state system 110 and the action system 120. The state system 110 includes a higher-level state vector s⁽ⁱ⁺¹⁾ 112, a state hypernetwork Hs⁽ⁱ⁾ 114 and a lower-level state function fs⁽ⁱ⁾ 116. Similarly, action system 120 includes a higher or higher-level action vector a⁽ⁱ⁺¹⁾ 122, an action hypernetwork Ha⁽ⁱ⁾ 124 and a lower-level action function fa⁽ⁱ⁾ 126. The index i is used to represent the levels of the APCN, with higher number indices indicating higher levels. So level i+1 is the level above level i for example, while level i−1 would be the level below level i.

Following the POMDP formulation, the state system 110 captures the transition dynamics of the environment. The action system 120 determines which action (actual or abstract) the agent will take toward solving the downstream task. The state system 110 maintains historical context via the recurrent state vector s 112 and the action system via the action vector a 122. The vectors are sequences of values which represent information about the state of the system and the action to be taken respectively. The nature of the vectors, such as their length, contents, organization, etc., may vary based on the APCN's application. The state and action networks which update these vectors are denoted by fs and fa, respectively. The state and action networks fs and fa 116 and 126 may be implemented by recurrent neural networks (RNNs) or transformer networks. Multiple modules such as 100 may be stacked by allowing the current state and action vectors 112 and 114 at any given level to generate an entire new state network 116 and action network 126 respectively at the level below using hypernetworks 114 and 124 respectively (“hypernet approach”). Alternately, instead of generating entire new state and action networks, the hypernetworks 114 and 124 may generate embedding inputs to state and action networks fs and fa 116 and 126 respectively (“embedding approach”).

The higher level is designated by the indices (i+1). Accordingly, the state and action vectors s⁽ⁱ⁺¹⁾ 112 and a⁽ⁱ⁺¹⁾ 122 represent the state and action vectors of a higher level. The higher level state vector s⁽ⁱ⁺¹⁾ is used as an input by the hypernetwork Hs⁽ⁱ⁾ 114 (denoting that the hypernetwork Hs is associated with generating the lower level (i)) to generate a lower-level state function fs⁽ⁱ⁾ 116. Similarly, the higher-level action vector a⁽ⁱ⁺¹⁾ 122 is used as an input by the hypernetwork Ha⁽ⁱ⁾ 124 to generate the lower-level action function fa(i) 126. Both the lower-level action and state functions 116 and 126 may be implemented as RNNs or transformer networks. The hypernetworks may generate the lower-level networks, may update the lower-level networks or combinations thereof, or alternately, in the embedding approach, the hypernetworks may generate embedding inputs to the lower-level networks and influence their computations through these inputs. The hypernetworks may be trained based off of the task which the APCN is intended to perform.

The lower-level state and action functions 116 and 126 may be used to generate lower-level state and action vectors (not shown in FIG. 1). For example, the lower-level state and action functions 116 and 126 may be in horizontal communication in order to generate the lower-level state and action vectors s(i) and a(i). Although not shown in FIG. 1, the higher-level state and action vectors 112 and 122 may themselves be products of higher-level state and action functions fs⁽ⁱ⁺¹⁾ and fa⁽ⁱ⁺¹⁾. In this manner, the generative module 100 may be used to build a layered APCN with multiple levels of state and action functions and vectors.

The use of a layered system may allow problems to be sub-divided, allowing compositional solutions to complex problems based on a “divide-and-conquer” strategy. In other words, a solution at a higher-level frame of reference may be developed by sub-dividing the frame of reference into lower-level frames of reference, generating lower-level solutions with respect to those lower-level frames of reference, and then combining the lower-level solutions to achieve a higher-level solution. For example, a higher level state vector s⁽ⁱ⁺¹⁾ may represent a state of an object, problem or environment (real or virtual), while a lower-level state vector s(i) represents a state of a portion of the object or environment. Similarly, the higher-level action vector a⁽ⁱ⁺¹⁾ may represent an action to be taken in relation to the whole object, problem or environment (e.g., selecting the part or portion), while a lower-level action vector a(i) represents an action to be taken with respect to the part or portion (e.g., selecting further sub-parts or sub-portions).

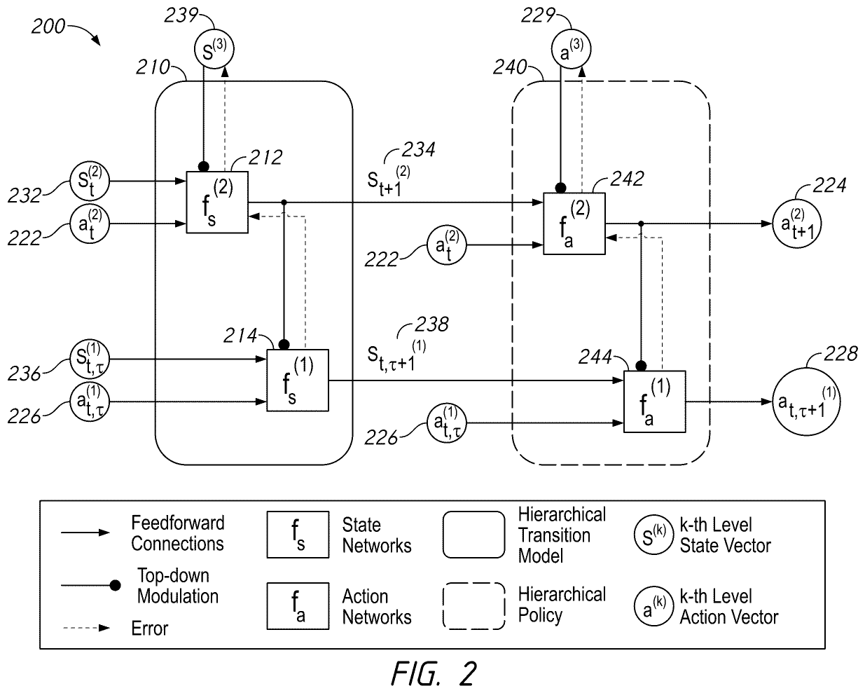

FIG. 2 is a block diagram of an APCN according to some embodiments of the present disclosure. The APCN 200 of FIG. 2 shows an example multi-level APCN which may be generated by the generative module 100 of FIG. 1. In particular, FIG. 2 shows an example implementation which shows three levels of an APCN, two of which are shown in detail, with a top level represented only by respective state and action vectors 239 and 229.

Similar to FIG. 1, the APCN 200 shows a number of action and state vectors s⁽ⁱ⁾ and a⁽ⁱ⁾. Also shown in FIG. 2 are example state and action functions fs⁽ⁱ⁾ and fa⁽ⁱ⁾ respectively. In the state and action vectors/functions, i is an index which indicates the level those action and state vector/functions are associated with. The higher the index value, the higher the level. In the example APCN 200, three levels are shown represented by the indices 3, 2, and 1 (from top to bottom). The state and action networks or functions 212, 214, 242, and 244 are implemented by RNNs or transformer networks. The state and action networks are generated by hypernetworks (not explicitly shown in FIG. 2) based on the vectors of the next higher level, for example based on the generative module 100 of FIG. 1 (in the embedding version of APCNs, the embedding inputs to the state and action networks are generated by hypernetworks). An alternative notation used herein is the use of uppercase letters to indicate higher level vectors and networks and lowercase letters to indicate lower-level vectors and networks. For example, the higher level vectors s⁽²⁾ and a⁽²⁾ may be represented as S and A, while the lower level vectors s⁽¹⁾ and a⁽¹⁾ may be represented as s and a. Similarly, the higher-level networks may be represented as Fs and Fa while the lower-level networks may be represented as fs and fa.

For the sake of explanation, two levels, denoted level 2 and level 1 are described in detail with respect to FIG. 2. However, more levels may be used. For example, vectors 239 and 229 from a level 3 are shown, although the other components of level 3 are not described in detail. Similarly, while not shown or described in FIG. 2, there may be a level 0 below level 1, and so forth. In general, the concepts of the APCN may be understood with respect to the interaction between two adjacent levels, so the interaction between the two levels 2 and 1 will be focused on. For example, the interactions between levels 3 and 2 may generally be similar to the interactions between level 2 and level 1, but with level 2 as the lower level instead of the higher.

The APCN 200 may perform a function by iterating one or more macrosteps at a higher level, and for each macrostep, performing one or more microsteps at the lower level. For example, a macrostep on level 2 may represent updating the level 2 state vector from a previous state 232 to a current state 234, and then updating the level 2 action vector from a previous state 222 to a current state 224 with the higher-level (level 2 in this case) state and action networks 212 and 242. At each macrostep, the lower-level (level 1) state and action networks 214 and 244 may be generated or updated. For each macrostep, one or more microsteps may be performed by using the lower-level state and action networks 214 and 244 to update the lower-level (level 1) state vector from a previous state 236 to a current state 238 and update the lower-level (level 1) action vector from a previous state 226 to a current state 228. If there are further levels below the lower level, the microstep on a lower level may in turn be the macrostep of that level with respect to a next level down. For example, the microstep of level 2 with respect to level 3, is a macrostep of level 2 with respect to level 1 and so forth.

In the present disclosure, the letter t will generally be used as an index of macrosteps, while the letter t will generally be used as an index of microsteps performed responsive to the macrostep. Accordingly, macrostep t+1 may be the macrostep after macrostep t, and the microstep τ+1 may be the microstep after microstep τ. For each macrostep there may be some number T₁ of microsteps. If the process runs for T2 macrosteps (and if the number of microsteps per macrostep remains constant) then there may be T₁*T₂ total steps. Depending on the embodiment, the number of steps T₁ and/or T₂ may be fixed or variable.

In some embodiments, for each macrostep, there may be a number of lower level microsteps before control is returned to a higher level and a next macrostep is performed. In some embodiments, there may be a fixed number of microsteps for each macrostep. In some embodiments, a termination condition may be used, such as an error falling below a certain threshold, a certain value being stable for a number of microsteps, a goal condition for the level being reached, other conditions, or combinations thereof. Similarly, the macrosteps may be limited to a fixed number of steps and/or a termination condition.

At a next macrostep, one or both of the higher-level vectors may be updated based on one or both of the lower-level vectors. For example, the higher-level state vector may be updated based, in part, on the lower-level state vector at the end of the microsteps. In other words, the higher-level state network may accept the previous state vector 232, the previous action vector 222, and the lower-level state vector 238 at the final microstep as inputs. The higher-level action vector may be updated based on the lower-level action vector in an analogous way. In some embodiments, rather than use the lower-level vectors directly, one or more values derived therefrom may be used. For example, one or more feedback networks may generate a value based on the lower-level vectors, or an error (e.g., prediction error or task error) may be determined and used as feedback.

The state and action vectors at the highest state, s⁽³⁾ 239 and a⁽³⁾ 229 in this example, may be initialized from an input to the APCN. The nature of the input, and thus the nature of the state and action vectors, may be application specific. For example, in applications such as visual perception, where the input is an image, then the input may be a bitmap file, and the action vector may indicate a location (e.g., via pixel coordinates) of a selected portion, while the state vector may represent a current reconstruction or estimation of the contents of that portion (e.g., an array of pixel intensities).

In this manner the APCN 200 may divide a problem into smaller components which are handled by a lower level. For example, the highest level state vector (in this case s⁽³⁾ 239) may represent information about an entire object or environment. The next level state vector s⁽²⁾ may represent information about a region of the object or environment while the layer below that s⁽³⁾ may represent information about a sub-region of that region. Similarly, the action vectors may represent actions to be taken with respect to the appropriate level of information. For example, the higher-level action vector may represent selecting the region. The lower-level state and/or action vectors may in turn be used to update higher level state and/or action vectors in order to build up information about the overall object or environment based on the more detailed examination of portions thereof at the lower levels. For example, as the lowest level of the APCN 200 updates information about a sub-region, the state vector representing the region may be updated to reflect increased information about the sub-region and/or changes in the sub-region caused by the operation of the lowest level action vector with respect to that sub-region.

Since the lower-level vectors may represent portions of the object or environment that the higher-level vectors represent, then in some embodiments the lower-level vectors may be portions of the information contained in the higher-level vectors. However, in some embodiments, the lower-level vectors may be distinct from the higher-level vectors. In some embodiments the lower-level vectors may be initialized as a portion of the higher-level vector, updated by the lower-level functions over the macrosteps, and then that portion of the higher-level vector may be updated based on the updated value of the lower-level vector.

In the example APCN 200 of FIG. 2, at the highest level (level 3) only the state and action vectors s⁽³⁾ 239 and a⁽³⁾ 229 are shown. At the next level down (level 2) networks fs⁽²⁾ 212 and fa⁽²⁾ 242 are shown along with assorted action and state vectors 222-224 and 232-234 as described in more detail herein. The level 2 state network fs⁽²⁾ 212 may be generated from the higher level state vector s⁽³⁾ 239 and the level 2 action network fa⁽²⁾ 242 may be generated from the higher level action vector a⁽³⁾ 229 using an APCN generative module, such as the module 100 of FIG. 1. For example a state hypernetwork (e.g., 114 of FIG. 1) generates fs⁽²⁾ 212 based on the input of s⁽³⁾ 239 to the state hypernetwork and an action hypernetwork (e.g., 124 of FIG. 1) generates fa⁽²⁾ 242 based on the input of a⁽³⁾ 229 to the action hypernetwork. In FIG. 2, and in other figures, the use of hypernetworks to generate lower-level functions is shown by a line with a circle at the bottom where the upper portion of the line is shown with the input and the lower portion with the circle is shown with the output function. As well as generation, the line may also represent updating the network. For example, the lower-level network may not need to be regenerated at each macrostep, but may instead have one or more of its existing parameters adjusted while other parameters are maintained between macrosteps. In another example, the hypernetworks may generate embedding inputs to the lower-level networks instead of generating entire networks (the embedding approach), and the lower-level networks are updated based on the embedding inputs from the hypernetworks but the existing parameters of these networks are maintained between macrosteps.

The second level of the APCN 200 is used to generate a lowest level (level 1) from the second level in a manner similar to how the third level was used to generate the second level. In other words, the generative module of FIG. 1 may be used to generate level 2 from level 3 and level 1 from level 2 (and other levels in models that have more levels). The lower level (level 1) includes a level 1 state network fs⁽¹⁾ 214 and a level action network fa⁽¹⁾ 244 as well as action and state vectors 236-238 and 226-228 as described in more detail herein. The two state networks 212 and 214 are part of a state system or hierarchical transition system 210 (e.g., 110 of FIG. 1) and the two action networks 242 and 244 are part of an action system or hierarchical policy system 240 (e.g., 120 of FIG. 1). While higher level networks are not shown (e.g., fs⁽³⁾ and fa⁽³⁾), they would also be part of the respective state system 210 and action system 240.

The state and action networks 212, 214, 242, and 244 may be implemented as RNNs or transformer networks. Each RNN or transformer network is a model generated or updated by the hyper network based on a respective vector in the level above. The networks (or functions) 212, 214, 242, and 244 may include parameters such as weights and/or biases. The hypernetwork may generate the parameters and/or change/update the parameters to generate or update the lower-level network. The state and action vectors s and a may be estimated by the recurrent activity vectors of the respective state and action networks fs and fa. The notation f(;θ) is used to denote a network parameterized by θ={Wl, bl} from l=1 to L, where W and b represent the weights and biases respectively of the layers 1 of a network which has layers from 1 to a maximum layer L. Thus, for example, the lower level state function 214 may be represented as fs(;θs) and the lower level action function 244 may be represented as fa(;θa).

At each macrostep, the new state and action vectors 234 and 224 are used to generate or update the lower-level state and action functions 214 and 244. The hypernetworks generate or adjusts parameters of the lower-level networks 214 and 244 based on the updated higher-level vectors 234 and 224. For example, at a macrostep t+1, the parameters of the level action network may be represented as θa(t+1)(=Ha(a(t+1)⁽²⁾)) where the hypernetwork Ha is a non-linear function. The hypernetwork Ha may be used to dynamically generate the parameters θa (or an embedding input) for the lower level network fa⁽¹⁾ 244 in order to implement a policy to generate primitive (e.g., lower-level) actions suitable for achieving the sub-goal associated with the current state of the higher-level action vector a(t)⁽²⁾ 224.

Similarly, at the macrostep t+1, the higher level state vector s(t+1)⁽²⁾ 234 is used in a similar fashion to devise a new reference frame in which the lower level operates. The higher level state s(t+1)⁽²⁾ 234 is provided as an input to a state hypernetwork (along with any other state relevant information) to generate or update the lower-level state network defined by the parameters θs. For example, θs(t+1)(=Hs(s(t+1)⁽²⁾)) where the hypernetwork Hs is a non-linear function. The hypernetwork specifies a dynamically generated lower level network (e.g., fs⁽¹⁾) which may be used to characterize the transition dynamics of a portion of the object or environment (or portion thereof) represented by the higher-level vector s⁽²⁾. In the embedding version, Es(t+1)(=Hs(s(t+1)⁽²⁾) where Es is the embedding input to the lower-level state network which is kept fixed between macrosteps.

The networks 212, 214, 242, and 244 each take various vectors as inputs and generate updated vectors as outputs. This process of generating an updated output vector from an input vector may be thought of as a time step, with the input representing the vector at a previous time and the output representing the vector at a subsequent time. The different levels may use different time steps. Time steps in the second level (level 2) are represented by the letter t which represents ‘macrosteps’, while time steps at the lowest level (level 3) are presented by the letter t which represents ‘microsteps’. Accordingly, the state and action vectors 222-224 and 232-234 at a higher level are indexed by the time t, but the state and action vectors at the lower level 226-228 and 236-238 are indexed by both t and t.

In an example implementation, at each time step on a higher level (e.g., level 2) or macrostep, a lower level (e.g., level 3) may be iterated for a number of time steps or microsteps before returning control back to the higher level. Other criteria may also be used to determine how many time steps are used in the lower level (e.g., a stop condition, a goal being reached, calculating the number of time steps based on one or more conditions, etc.). When control returns to the higher level (e.g., at the end of a set of microsteps) the state and/or action vectors may be updated based on the lower-level state or action vectors (e.g., as part of the next macrostep). In some embodiments, the lower-level vectors generated from each microstep may be used to adjust the higher-level vectors.

Each state function (e.g., 212 or 214) accepts the previous state and action vectors on that level as inputs and provides a next state vector as an output. For example, the higher-level state vector fs⁽²⁾ 212 accepts state vector st⁽²⁾ 232 and action vector at⁽²⁾ 222 as inputs and provides the current state vector s(t+1)⁽²⁾ 234 as an output. The lower-level state function fs⁽¹⁾ 214 is generated by a hypernetwork based on the current higher-level state vector s(t+1)⁽²⁾ 234. The lower-level state function fs⁽¹⁾ accepts the previous lower-level state and action vectors s(t, τ)⁽¹⁾ 236 and a(t, τ)⁽¹⁾ 226 as inputs and provides a current lower-level state vector s(t, τ+1)⁽¹⁾ 238 as an output.

Each action function (e.g., 242 or 244) accepts that levels current state vector and previous action vector as inputs to generate the current action vector. For example, the higher-level action vector fa⁽²⁾ 242 accepts the current state vector s(t+1)⁽²⁾ 234 provided by the state function fs⁽²⁾ 212 and the previous action vector a(t)⁽²⁾ 222 as inputs and generates the current action vector a(t+1)⁽²⁾ 224. A hypernetwork generates or updates the lower-level action network 244 based off of the current action vector a(t+1)⁽²⁾ 224. The lower-level action network fa⁽¹⁾ 244 accepts the previous action vector a(t, τ)⁽¹⁾ 226 and the current lower-level state vector s(t, τ+1)⁽¹⁾ 238 from the state function fs⁽¹⁾ 214 as inputs and uses them to generate the current lower-level action vector a(t, τ+1)⁽¹⁾ 228. The contents of the state and action vectors, as well as what operations the state and action functions perform may all be application dependent.

In some embodiments, the lower-level functions may provide error information back to the higher-level function within the same system. So the lower-level state function fs⁽¹⁾ 214 provides an error signal to the higher-level state function fs⁽²⁾ 212 and the lower-level action function fa⁽¹⁾ 244 provides an error signal to the higher-level action function fa⁽²⁾ 242. The error signals may be used as feedback to help adjust the higher-level vectors.

For example, an input may be predicted using a generic decoder network by providing the lower-level state vector s(t,τ)⁽¹⁾ 236 to the decoder network to generate a predicted input. This predicted input is compared to the actual input to generate a prediction error ε(t,τ). For example, if the lower-level network is being used to characterize the contents of an image, then the predicted and actual inputs may be the information the lower-level network expects in that portion of the image and the actual information in that portion of the image. The prediction error is used to update the state vector s(t, τ)⁽¹⁾ using the state network fs⁽¹⁾ 214. For example, the updated higher-level state vector may be represented as s(t, τ+1)⁽¹⁾=fs(s(t, τ)⁽¹⁾, a(t, τ)⁽¹⁾, ε(t, τ); θs(t)). In some embodiments, the updated higher-level action vector may be updated in a similar fashion based on an error derived from the lower level.

In some embodiments, the higher level activity vector a(t+1)⁽²⁾ 224 may also be updated using information from the lower-level state vectors. In some embodiments, the higher-level activity vector may be updated based on the lower-level state vectors from each microstep. In this manner, the lower level may be generated from the higher-level information to sub-divide the problem. The lower level may then operate for a number of microsteps to update the information in the lower-level vectors, and then the higher-level vectors may be updated based on the updated lower-level vectors. This may allow refinement of the higher level one portion at a time.

The APCN 200 may, in some embodiments, need to initialize one or more components. For example, the initial state vector (e.g., s(t=0)⁽³⁾) and/or the initial action vector (e.g., a(t=0)⁽³⁾) may need to be initialized in order to allow the APCN 200 to begin developing subsequent states and action vectors and networks. In some embodiments, the initialization may be random or semi-random. In some embodiments, an initialization function or network may be used, which generates an initial value based on an higher-level value.

The various networks of the APCN 200 may be trained. For example, since the state networks fs 212 and 214 are task-agnostic and geared toward capturing the dynamics of the world, they are trained using self-supervised learning by minimizing prediction errors. A process such as backpropagation may be used, although other processes may be used in other example embodiments. The action networks fa 242 and 244 may be trained to integrate the information provided by the state vectors 232-238 toward a downstream task by minimizing the total expected task loss. For example, this may be done with either reinforcement learning or with planning with the help of the state networks. Reinforcement learning is discussed in more detail with respect to an example application for visual perception (below), while planning is discussed in more detail with respect to an example application for hierarchical planning (below). However, either approach may be used for various different types of application.

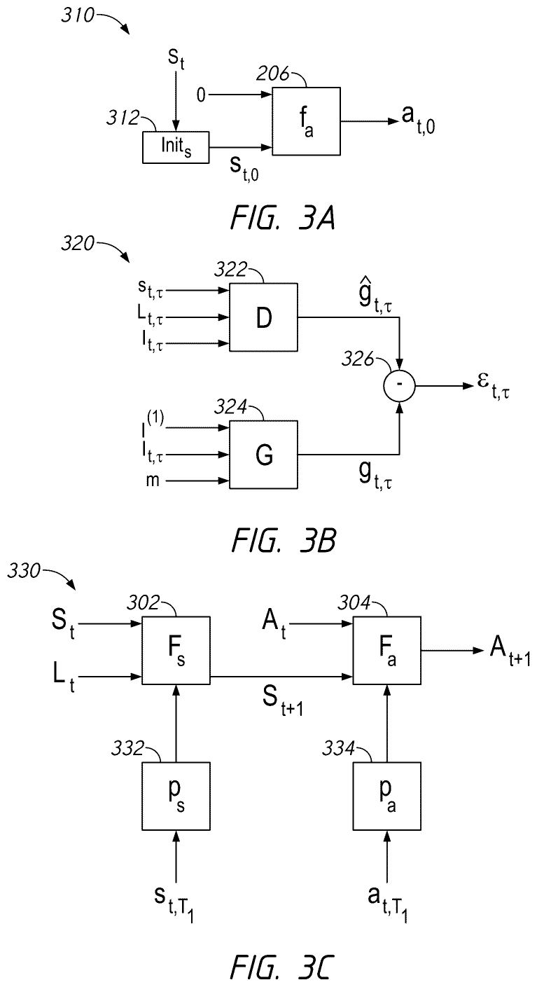

FIGS. 3A-3C are block diagrams which show various additional networks or systems which may be used along with an APCN according to some embodiments of the present disclosure. FIGS. 3A-3C show various components which may represent optional features which may be useful to an APCN, such as the APCN 200 of FIG. 2. For example, FIG. 3A shows an initialization system 310, FIG. 3B shows an error determination system 320, and FIG. 330 shows an update system which updates higher level vectors based on lower-level vectors.

FIG. 3A shows an initialization system 310. The initialization system 310 includes a an initialization network 312 which generates an initial value of a lower level state vector s(t, τ=0), for a first micro-step triggered off of a macrostep t. The lower-level state vector s may be the vector 236 of FIG. 2. At the beginning of each micro-step, the higher-level state Sₜ (e.g., 234 of FIG. 2) is used to initialize the bottom-level state vector via a network Initₛ 312 to produce the initial value of the state vector s_{t,0}=Initₛ(Sₜ). The initialization network Init 312 may be a feedforward network. The initialized value s(t,0) is then used as in input to the lower-level action network 206 (e.g., 244 of FIG. 2) along with an empty action vector. The lower-level action network generates an initial action vector a(t,0). Subsequent microsteps may then use the initialized values s(t,0) and a(t,0) to generate subsequent updated values of the action vectors s and t.

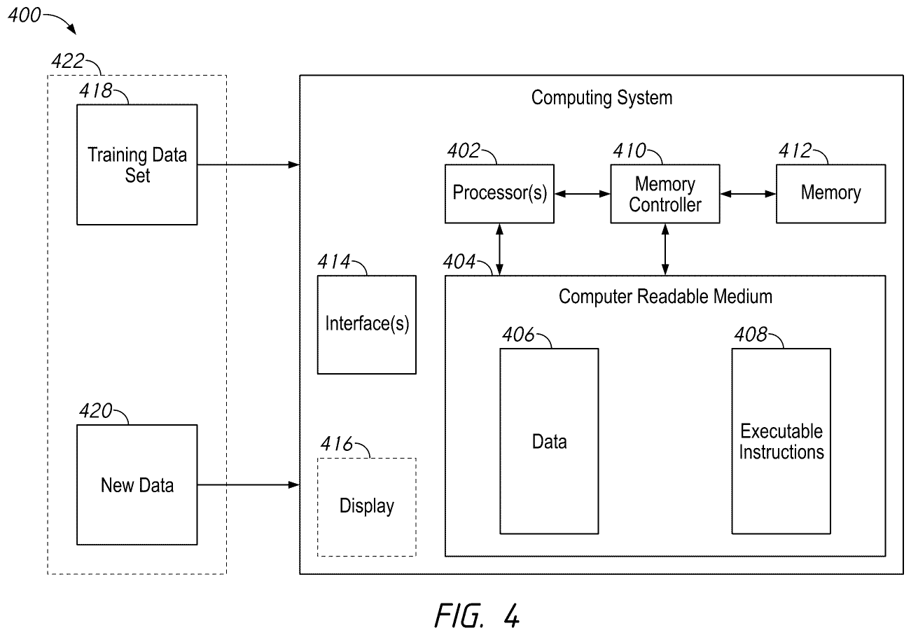

FIG. 3B shows an error determination system 320. The error determination system 320 may be used to generate an error ε which is used as feedback to an higher-level network. The bottom-level action RNN updates its activity vector a_{t,τ} based on the current state and past action, and a location l_{t,τ} is chosen as a function of a_{t,τ}. This results in a glimpse image g_{t,τ}=G(lₜ⁽¹⁾, l_{t,τ}, m) of scale m centered around l_{t,τ} within image sub-region lₜ⁽¹⁾ specified by the higher level (FIG. 4c). The frames of reference and the corresponding image sub-regions across the two levels are depicted in FIG. 2b.

To predict the next glimpse image at the location specified by the action network, the lower-level state vector r_{t,τ}, along with locations Lₜ and l_{t,τ}, are fed to a generic decoder network D to generate the predicted glimpse ĝ_{t,τ}. This predicted glimpse is compared to the actual glimpse image to generate a prediction error ϵ_{t,τ}=g_{t,τ}−ĝ_{t,τ}. Following the predictive coding model, the prediction error is used to update the state vector via the state network: r_{t,τ+1}=fs(r_{t,τ}, ϵ_{t,τ}, lₜ; θ^{(s)}(t)) (FIG. 3B, lower left). For the bottom-level locations,=the same Gaussian noise-based exploration strategy is used as the top-level.

FIG. 3C shows an update system 330 which may be used to update the higher-level state and action vectors based on the results of the operation of the lower-level system. The update system 330 includes a state feedback network 332 and an action feedback network 334. The state feedback network 332 takes the lower-level state vector s at the end of the microsteps as an input and provides an input to the higher-level state network 302 (e.g., 212 of FIG. 2) which in turn generates a new higher-level state vector S(t+1). Similarly, the action feedback network 334 takes the lower-level action vector a at the end of the microsteps as an input and provides an input to the higher-level action network Fa 304 (e.g., 214 of FIG. 2) which in turn generates a new higher-level action vector A(t+1). The networks 332 and 334 may, in some embodiments, represent single layer feedback networks. The updating of S and A based on the feedback networks 332 and 334 may represent the termination of microsteps for a given macrostep, and the return of ‘control’ to the higher level of the network.

FIG. 4 is a schematic illustration of a computing system arranged in accordance with examples of the present disclosure. The computing system 400 may be used to implement one or more machine learning models, such as the APCN described in FIGS. 1-3.

The computer readable medium 404 may be accessible to the processor 402. The computer readable medium 404 may be encoded with executable instructions 408. The executable instructions 408 may include executable instructions for implementing a machine learning model to, for example, parse an image or perform navigation. The executable instructions 408 may be executed by the processor 402. In some examples, the executable instructions 408 may also include instructions for generating or processing training data sets and/or training a machine learning model. Alternatively, or additionally, in some examples, the machine learning model, or a portion thereof, may be implemented in hardware included with the computer readable medium 404 and/or processor 402, for example, application-specific integrated circuits (ASICs) and/or field programmable gate arrays (FPGA).

The computer readable medium 404 may store data 406. In some examples, the data 406 may include one or more training data sets, such as training data set 418, data generated during the networks interaction with the environment or problem, or combinations thereof. The training data may be based on a selected application. For example, the training data set 418 may include one or more sequences of images. In some examples, training data set 418 may be received from another computing system (e.g., an imaging system 422, a cloud computing system). In other examples, the training data set 418 may be generated by the computing system 400. In some examples, the training data sets may be used to train one or more machine learning models. In some examples, the data 406 may include data used in a machine learning model (e.g., weights, connections between nodes). In some examples, the data 406 may include other data, such as new data 420. The new data 420 may include one or more image sequences not included in the training data set 418. In some examples, the new data may be analyzed by a trained machine learning model to recognize the contents of the image. In some examples, the data 406 may include outputs (e.g., displaying an identity of the image, performing an action based on the image, directing a physical vehicle or drone based on the navigation, etc.) generated by one or more machine learning models implemented by the computing system 400. The computer readable medium 404 may be implemented using any medium, including non-transitory computer readable media. Examples include memory, random access memory (RAM), read only memory (ROM), volatile or non-volatile memory, hard drive, solid state drives, or other storage. While a single medium is shown in FIG. 4, multiple media may be used to implement computer readable medium 404.

In some examples, the processor 402 may be implemented using one or more central processing units (CPUs), graphical processing units (GPUs), ASICs, FPGAs, or other processor circuitry. In some examples, the processor 402 may execute some or all of the executable instructions 408. In some examples, the processor 402 may be in communication with a memory 412 via a memory controller 410. In some examples, the memory 412 may be volatile memory, such as dynamic random-access memory (DRAM). The memory 412 may provide information to and/or receive information from the processor 402 and/or computer readable medium 404 via the memory controller 410 in some examples. While a single memory 412 and a single memory controller 410 are shown, any number may be used. In some examples, the memory controller 410 may be integrated with the processor 402.

In some examples, the interface 414 may provide a communication interface to another device (e.g., imaging system 422), a user, and/or a network (e.g., LAN, WAN, Internet). The interface 414 may be implemented using a wired and/or wireless interface (e.g., Wi-Fi, BlueTooth, HDMI, USB, etc.). In some examples, the interface 414 may include user interface components which may receive inputs from a use. Examples of user interface components include a keyboard, a mouse, a touch pad, a touch screen, and a microphone. In some examples, the interface 414 may communicate information, which may include user inputs, data 406, training data set 418, and/or new data 420, between external devices (e.g., imaging system 422) and one or more components of the computing system 400 (e.g., processor 402 and computer readable medium 404).

In some examples, the computing system 400 may be in communication with a display 416 that is a separate component (e.g., using a wired and/or wireless connection) or the display 416 may be integrated with the computing system. In some examples, the display 416 may display data 406 such as outputs generated by one or more machine learning models implemented by the computing system 400. Any number or variety of displays may be present, including one or more LED, LCD, plasma, or other display devices.

Table 1, below, shows an example implementation of an APCN which may be loaded in the computing system 400. For example, Table 1 is represented as pseudo-code instructions which may be loaded into the memory 412 to be executed by the processor 402. The pseudo-code of Table 1 shows an example implementation of an APCN which is described generically with respect to two example applications, visual perception and hierarchical planning. Visual perception may be used to classify or reconstruct the contents of an image based on relatively restricted information about the image (e.g., glimpses of regions of sub-regions rather than full information about the entire image). Hierarchical planning may be used to sub-divide a problem, such as navigating to a goal in an environment, into sub-problems. Those two example applications are described in more detail herein.

The Example of Table 1 shows a two-level APCN, where each level executes for a fixed number of steps. In particular, the higher level may perform T₂ macrosteps and at each macrostep the lower level may perform T₁ microsteps. However, other conditions may also be used. For example, the microsteps may continue operating until a stop condition is reached (e.g., for τ=1 until stop condition=True do . . . ).

TABLE 1
Example APCN Pseudo-Code Implementation

```
Assumptions: A two-level APCN model.
Parameters : θ_{RN N} for Fs , Fa, and θ_{N N} for Hs and Ha
Data : Episodic transitions from environment for navigation; or a set of glimpse
      images for visual reconstruction
Result: Trained two- level APC network that can efficiently navigate to a goal in the
environment; or effectively reconstruct images with few glimpses
// Initialization
Initialize top-level state and action vectors S₀, A₀ randomly for navigation or via a
  random glimpse for reconstruction;
Optionally initialize bottom- level states and actions s_{0,0} and a_{0,0} using an initialization
network;
// Training
for a sample transition or glimpse in Data do
    for t = 1 to T₂ do
        Generate lower state network weights θs = Hs(St);
          Generate lower action network weights θa= Ha(At) ;
      for τ = 1 to T1 do
            θs, parameterizes fs, and θa parameterizes fa;
            Obtain gradients for lower-level transition model fs(s(t,τ+1)|s(t,τ), a(t,τ)) with
              respect to prediction loss over states/glimpses;
            Obtain gradients for lower-level policy fa(a(t,τ+1)|s(t,τ+1), a(t,τ)) via
              policy gradient loss over environment rewards or reconstruction success, or
              via planning to infer actions;
      end
      Obtaining gradients for higher-level transition model Fs(S(t+1)|St, At) with
        respect to prediction loss;
      Obtain gradients for higher-level policy Fa(A(t+1)|S(t+1),At) with respect to
        policy gradient loss;
    end
    Adjust model parameters using the obtained gradients
end
```

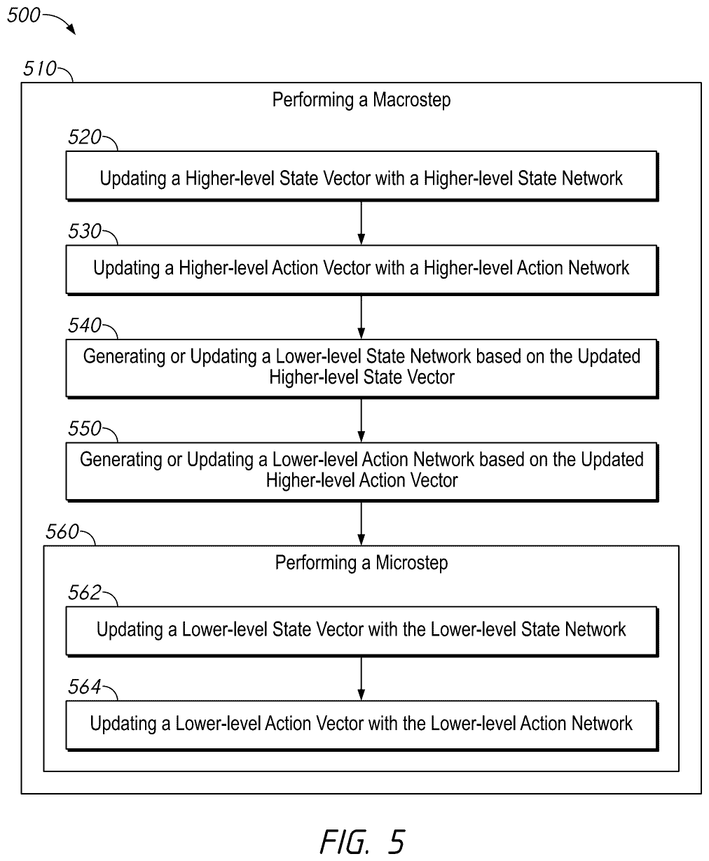

FIG. 5 is a flow chart of a method of operation of an APCN according to some embodiments of the present disclosure. The method 500 may represent the operation of an APCN or portion thereof such as the ones discussed in FIGS. 1-3. The APCN may be implemented on a computing system, such as the computing system 400 of FIG. 4. For example, the method 500 may represent the operation of pseudo-code similar to the example pseudo-code in Table 1.

The method 500 is generally described with respect to the operation of macrosteps of a higher level and microsteps of a lower level. The higher and lower level may represent two adjacent levels of an APCN. For example, the operation of level 2 and level 1 of FIG. 2. In some embodiments, the method may represent the operation of two adjacent levels of a larger APCN structure. For example, the microsteps of FIG. 5 may in turn be the macrosteps of a next level down and so forth.

The method may generally begin with imputing a representation of an object, environment or problem to the APCN and initializing a higher-level state vector based on a first frame of reference which represents all or part of the object, environment or problem. For example, the representation may be a data file, such as an image represented as a bitmap or other suitable file format. In some embodiments, the representation may be data captured which represents a real object or environment, such as a picture taken by a camera. In some embodiments, the representation may be of a virtual object or environment, such as a data file which represents the locations of objects within a simulation.

The higher-level state vector may be initialized based on the representation. In some embodiments, the representation may be used directly as the higher-level state vector. In some embodiments, the representation may be processed to extract information, add additional information, or otherwise used to generate the higher-level state vector. In some embodiments, the initialization may be random or semi-random. For example, if the APCN is trained to reconstruct an image based on glimpses, then the input may be an image, and the initialized higher-state vector may be estimated from a randomly selected glimpse (or portion) of the image.

The blocks 510-560 of the method represent an iterative process which is performed after initializing the higher-level state vector. After performing the steps of the blocks 510-560 one or more times, the method may include outputting the updated higher-level state vector, the updated higher-level action vector or combinations thereof. In some embodiments, the higher-level state vectors or action vectors at each macrostep may be saved and then combined to yield an overall result. For example, if each updated state vector represents a reconstruction based on different lower-level glimpses, then the overall output may be an overall reconstruction based on all of the individual higher-level reconstructions (higher-level state vectors) combined. Other example applications may use the action vector as an output. For example, if each updated action vector represents a set of steps to navigate a portion of an environment (e.g., a building) then the action vectors may be combined to yield a set of instructions which navigate the entire building.

The method 500 includes block 510, which describes iteratively performing one or more macrosteps. The one or more macrosteps may be iteratively performed to sub-divide the first frame of reference into portions. Performing the macrostep 510 includes blocks 520-560 as described herein. Block 520 describes updating a higher-level state vector (e.g., S 232) with a higher-level state neural network (e.g., Fs 212). For example, the method 500 may include generating an updated higher-level state vector (e.g., 234 of FIG. 2) based on a previous higher-level state and action vector by using them as inputs to the higher-level state neural networks. The higher-level state neural network (e.g., Fs) may be trained to determine a current state of the first frame of reference. The higher-level state neural network may be trained based off of training data, or may be trained by a hypernetwork using information from a level of the APCN above the higher level. In some embodiments, the method 500 may include generating the higher-level state vector based on the pervious state and action vectors and on a lower-level state vector, action vector, or combination thereof. The lower-level state and action vectors may represent the state of the lower-level state and action vectors as the end of a previous set of microsteps.

Block 510 may be followed by block 520, which describes updating a higher-level action vector with a higher-level action neural network. Block 520 may be generally analogous to block 510, except the action neural network (e.g., Fa 242 of FIG. 2) and action vectors (e.g., A 222/224 of FIG. 2) are used. The method may include generating the updated action vector based on a current state vector (e.g., the output of the state network at the current macrostep) and the previous action vector. Similar to the state vector, the action vector may also be updated based on the lower-level state and/or action vectors (e.g., from the end of the previous microsteps). The higher-level action neural network may be trained to select a second frame of reference which is a selected portion of the first frame of reference. For example, the second frame of reference may be a portion of the image (or portion thereof) represented by the first frame or reference, or a repeating sub-unit of the environment represented by the first frame of reference. Depending on the application, the higher-level action neural network may be trained to select the second reference frame based on application specific criteria. For example, based on areas more likely to help identify an object within an image, or to look for repeating sub-units of a more complex environment/maze.

The macrostep 510 also includes block 540 which describes generating or updating a lower-level state network (e.g., fs 214 of FIG. 2) based on the updated higher-level state vector and block 550 which describes generating or updating a lower-level action network (e.g., fa 244 of FIG. 2) based on the updated higher-level action vector. For example, a state hypernetwork (e.g., Hs 114 of FIG. 1) may generate the lower-level state network and an action hypernetwork (e.g., Ha 124 of FIG. 1) may generate the lower-level action network. The state and action hypernetworks may be trained to generate the lower-level networks based on training data, data generated from interactions with the environment or problem, or combinations thereof before the method 500 is performed. The training data may be application specific in order to generate lower-level neural networks which perform application specific tasks. The generating/updating may include generating or updating parameters of the lower-level networks such as weights, biases, or combinations thereof. The method 500 may include training the state and action hypernetworks based on a task to be performed by the APCN.

For each macrostep, the method 500 includes block 560 which describes performing one or more microsteps. Each microstep includes blocks 562 and 564 which describe updating a lower-level state vector (e.g., s 236/238 of FIG. 2) with the lower-level action network and updating a lower-level action vector (e.g., a 226/228 of FIG. 2) with the lower-level action network. The operation of the lower-level may generally be analogous to the operation of the higher-level as described with respect to blocks 520 and 530 except with lower-level vectors instead of higher-level vectors. For the sake of brevity details already described with respect to blocks 520 and 530 will not be repeated again with respect to blocks 562 and 564. The lower-level state neural network is trained to determine a current state of the selected second frame of reference. The lower-level action neural network is trained to analyze or perform an action with respect to the current state of the selected second frame of reference. For example, if the application is navigation, the lower-level action neural network may generate a set of directions or instructions.

In some embodiments, the method 500 may include initializing the lower-level state vector, the lower-level action vector or both during a first microstep of the one or more microsteps. For example the method 500 may include initializing the lower-level state vector with an initialization network (e.g., 312 of FIG. 3) and initializing the lower-level action vector based on the initialized lower level state vector with the lower-level action network. In some embodiments, the initialization may be random or semi-random.

In some embodiments, the method 500 may include performing a set number of microsteps (e.g., repeating box 560) before performing a next macrostep (e.g., repeating box 510). In some embodiments, microsteps 560 may continue until a termination condition is reached before a next macrostep is performed.

In some embodiments, the method 500 may include updating the higher-level vectors based on the lower-level vectors. For example, at the end of the microsteps, the next macrostep may include updating the higher-level vectors based, in part, on the lower-level vectors. For example, the method 500 may include determining an expected input based on the lower-level state vector and the lower-level action vector with a decoder (e.g., 322 of FIG. 3), determining an actual input based on the lower-level action vector and comparing the predicted input with the actual input to generate an error. The method 500 may include updating the higher-level state vector based on the error. In another example, feedback networks (e.g., 332 and 334 of FIG. 3) may be used to update the higher-level vectors based on the lower-level.

Two example applications of an APCN, such as the APCN 200 of FIG. 2 and/or the components thereof such as in FIGS. 1 and FIGS. 3A-3C, and its operation, such as discussed in FIG. 5, are discussed below. A first example application is described with respect to visual perception, which may be used for machine vision (e.g., to classify objects in an image). A second example application is described with respect to hierarchical planning, e.g., to navigate a floor in a building, represented as structured maze. While certain details may be specific to the implementation used for that example, in general the details described with respect to the two example applications may be applied to other applications. For example, the first example is described with respect to reinforcement learning and the second is described with respect to planning; however, either method of training may be used for either application. Similarly, these two example applications are merely illustrations of how the APCN might be adapted to a specific application, and APCNs may be used for other example applications.

### Example 1—Visual Perception

In a visual perception APCN, the APCN may examine an image, for example to classify the identity of the contents of the image. The APCN is given the image as an input to a higher level. The higher-level state vector may be initialized based off of that image. Each successive lower level examines portions (or sub-portions) of that image. The output of the APCN may be a reconstruction of an object contained in that image.

The APCN of Example 1 will generally be described as a two level APCN, although more levels may be used in other example embodiments. The higher level operates with respect to the whole image, while the lower level operates with respect to a selected portion of the image. The higher level may select a portion of the image to example, and then the lower level may select one or more sub-regions within that region to example. By updating knowledge about the regions and sub-regions, and overall identify of the contents of the image may be determined. In this manner a reconstruction or estimation of the overall image may be generated from relatively few ‘glimpses’ of small sub-regions of the image. This may also be useful to training the APCN to learn part-whole hierarchies about the object or objects in the image.

The actions of the APCN in analyzing the image may be thought of as generally analogous to how human eye movements (or attention) is used to analyze an object. The APCN uses a ‘glimpse sensor’ to extract information from a portion of the image. The APCN may use recursive object-centered reference frames. This, in turn, may allow spatial up the representational hierarchy, capturing the inductive bias that an entity has a larger spatial extent than its constituent parts. The top level of the APCN spans the entire image and at each macrostep the APCN chooses a region of the image to focus on. It then generates a lower-level image parser (comprising state-action subnetworks) and assigns this image region as the input to the lower level. The bottom-most level has direct access to the image via small-sized glimpses. The APCN model performs a type of depth-first exploration of the representational graph, where each layer descends deeper into the graph with a new object-centered reference frame. These stacks of reference frames can be composed to derive the absolute location of any sampled glimpse within the image.

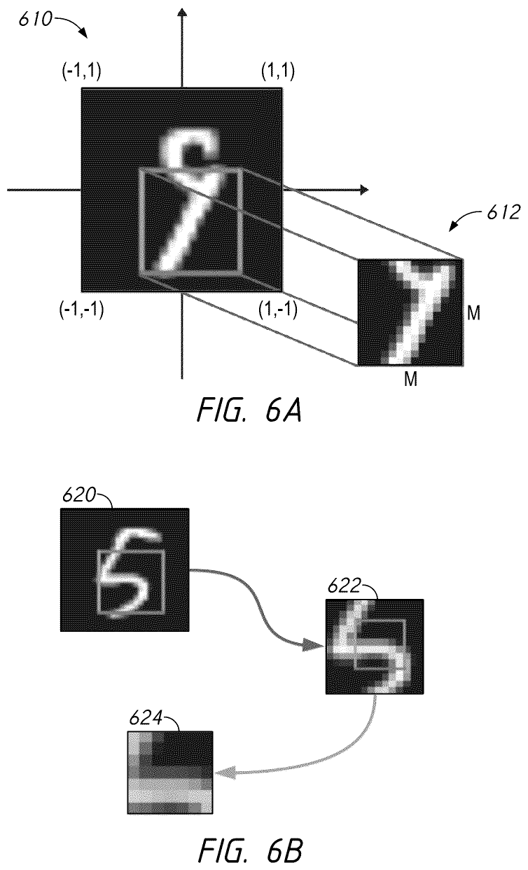

FIGS. 6A-6B are images showing reference frames as an example of an operation of an APCN used for visual perception. FIG. 6A shows an example operation of a single macrostep (e.g., an operation of a higher level), and FIG. 6B shows an example operation of macrostep and an microstep. The example operation may be useful to visualize the operation of the APCN, although it is not necessary for an APCN to produce graphics or displays at each step.

FIG. 6 is described with respect to various definitions and terminology in terms of the images to be analyzed which will generally be used in describing Example Application 1 (e.g., FIGS. 6-11). Images 610 and 620 represent example images which may be used as example inputs to the APCN. In the case of both images 610 and 620, the images contain a scan of a handwritten character, the numeral 9 in image 610 and the numeral 5 in the image 620. The images 610 and 620 may be generalized as an image I with N×N pixels. While the example implementations of the present disclosure are generally described with respect to square images, other example embodiments may use rectangular or other shapes of images. For the sake of reference, the image I may have its dimensions normalized such that the range of pixels spans from −1 to 1 on an x-y axis (shown for image 610 but not for image 620). In other words one corner of the image may be at coordinates (1,1) while the other corner is at (−1,−1).

A glimpse sensor G is used to extract a selected region of the image. The selected region may be at a specified location l, and of a size scale m compared to the original image. Accordingly, the glimpse sense may generate a region or patch g=G(I, l, m) shown as region 612 of FIG. 6A and region 622 of FIG. 6B. The size scale m may be a value between 0 and 1. For example a value of 0.25 would make the region ¼ the size of the overall image. In some embodiments, the size scale m may be hard coded for each level of the APCN and may be the same or different on different levels. The glimpse 612 or 622 may be of size P×P where P=N*m.

The location l may represent an output of the action system of the APCN. For example, the location l may be selected based on the higher-level action vector (e.g., 224 of FIG. 2). The action system may be trained to select regions which can be of particular use to characterizing the object contained in the image. For example, in FIG. 6A, the selected region 612 covers a lower portion of the digit ‘9’ showing the downward stroke. This may be useful, for example in differentiating the character from an ‘8’ which also has a loop in its upper portion. In some embodiments, since/is continuous, the glimpse sensor may be implemented using a differentiable bilinear interpolation module.

In FIG. 6B, the glimpse sensor is shown operating a second time on the region 522 chosen by the higher-level portion of the APCN. The lower-level portion of the APCN performs in a similar manner and instructs the glimpse sensor to select a further subregion 624 of the region 622 selected by higher level network. At each macrostep the higher-level network may select a different region such as 612 or 622, and then perform a number of microsteps to examine subregions (e.g., 624) within that region. In this manner, an overall identity of the object in the image I may be developed.

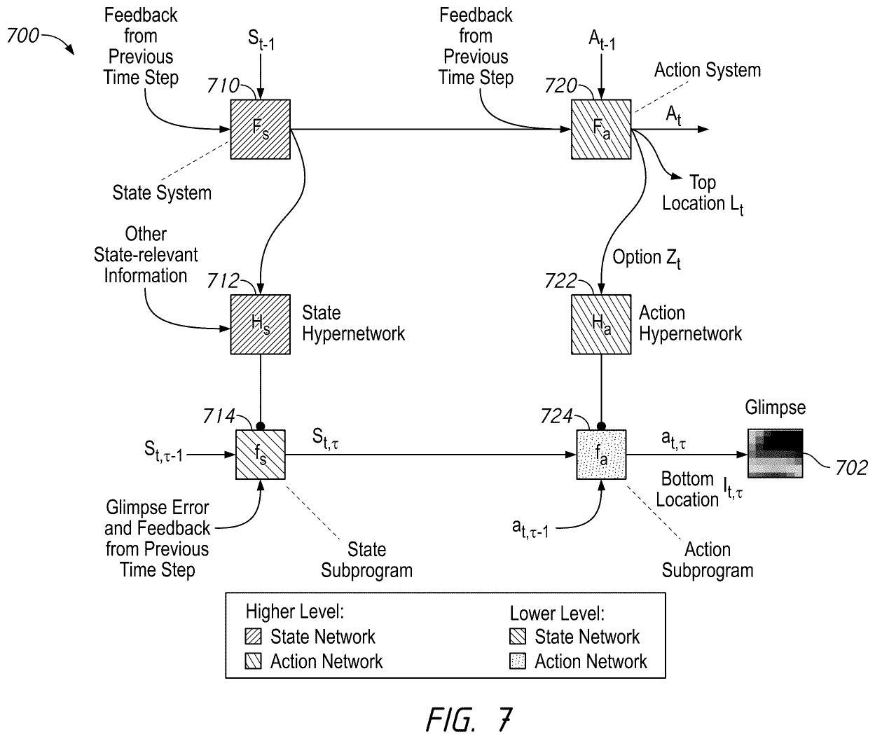

FIG. 7 is a block diagram of an example implementation of an APCN for visual perception according to some embodiments of the present disclosure. The APCN 700 of FIG. 7 may be an implementation of the APCN 300 of FIG. 3, and may, in some embodiments, be operated by a computing system such as 400 of FIG. 4 in a manner analogous to the method 500 of FIG. 5. The APCN 700 may perform the operations described with respect to FIGS. 6A-6B, as well as the other example operations described in FIGS. 6-11.

Since much of the APCN 700 of FIG. 7 may generally be similar to the APCN 300 of FIG. 3, for the sake of brevity certain features, details, and operations already described with respect to FIG. 3 will not be repeated with respect to FIG. 7.

The APCN 700 includes a higher level state network 710 (e.g., 212 of FIG. 2) and a higher level action network 720 (e.g., 242 of FIG. 2), here denoted as Fs and Fa. The higher-level state and action networks 710 and 720 operate on state vector St and an action vector At which represent a higher level state/action at a macro time step t. The action vector At includes higher level location information Lt, which may be used to instruct a glimpse sensor to select a region of the image (e.g., selecting region 612 or 622 of FIGS. 6A-B). A state hyper network 712 (e.g., 114 of FIG. 1) and an action hypernetwork 722 (e.g., 124 of FIG. 1) generate parameters θs and θa respectively for lower-level state network fs 714 (e.g., 214 of FIG. 2) and lower-level action network fa 724 (e.g., 244 of FIG. 2). The lower level state and action networks 714 and 724 operate on lower level state and action vectors s(t,τ) and a(t,τ) where t represents the macro time step and t represents the micro time step of the lower level. The lower level action vector includes a lower level location l(t,τ) which may be fed to a glimpse sensor 702 to generate a glimpse of a sub-region (e.g., 624 of FIG. 6B). The same glimpse sensor 702 or a different one may also operate with the higher-level location Lt.

The top-level state vector St may receive continuous feedback from the lower levels. However, in this embodiment, the lower level network parameters θs and θa are generated at the beginning of each macrostep using only S(t, τ=0) and A(t, τ=0) respectively. In other words, network parameters θs and θa may stay fixed during a single macrostep for each of the microsteps of that macrostep, but may change from macrostep to macrostep. When the lower level is initialized, a initialization network (e.g., 312 of FIG. 3B) is used to initialize s(t, τ=0) using S(t, τ=0) as an input to the initialization network. The initial lower level state vector s(t, τ=0) is used as an input to the lower level state network fs 714 to generate an initial value of the lower level action network a(t, τ=0).

At each macrostep t, the higher level of the APCN 700 updates its activity vector At and generates two values from the action vector At, a location Lt and a macro-action (or option) zt. The location Lt is used to select a region which defines an operational region for the lower level. For example, the location Lt may be used to restrict the lower level to a region I(t)=G(I, Lt, M) corresponding to a region of scale M centered around the selected location Lt. The scale factor M may be the scale factor represented as m in FIGS. 6A-B, however in this figure M is used as the scale factor for the higher level and m is used as a scale factor for the lower level. The option zt is used as an embedding vector which is input to the action hypernetwork 722. In other words, the lower-level parameters θa(t)=Ha(zt). In this embodiment, in order to allow exploration during reinforcement learning, the higher-level Location L̅ₜ derived from the action vector At may be treated as a mean or average location La and add a gaussian noise with fixed variance to the mean value Lₜ and add Gaussian noise with fixed variance to sample an actual location: Lt=L̅ₜ+ϵ, where ϵ˜ [symbol] (0, σ²). A similar operation may also be performed on the option zₜ.

In this embodiment, the state vector St and the location Lt are used as inputs to the state hypernetwork 712 to generate the lower-level state parameters θs(t)=Hs(S(t,τ=0), Lt). In this manner the state hypernetwork 712 may generate a dynamically generated bottom level state network 714.

At the beginning of each set of microsteps, the higher level state S(t,τ=0) is used to initialize a new lower-level state s(t, τ=0) which in turn is used to generate a(t, τ=0). Each microstep proceeds in a manner similar to the macrosteps at the higher level, with the state and action vectors s and a being used to generate an updated action vector a(t, τ) which is used to generate a lower-level location l(t, τ). The lower-level location is fed to the glimpse sensor 702 to generate a sub-region glimpse g(t, τ)=G(I(t), l(t,τ), m) where the sub-region glimpse (e.g., 624 of FIG. 6) is centered at location l(t, τ) and represents m percent of the overall area of the image region I(t) (which was the region glimpsed based on Lt at the higher level).

An error system, such as the error system 320 of FIG. 3B may be used to compare predicted glimpses to the actual glimpses in order to generate an error ε. The error, in turn, may be used as feedback to update the higher-level state vector St via the state network 710. To predict the next glimpse image at the location specified by the action network, the lower-level state vector st,τ, along with locations Lt and lt,τ, are fed to a generic decoder network D (e.g., 322 of FIG. 3) to generate the predicted glimpse ĝ(t,τ).

This predicted glimpse is compared to the actual glimpse image to generate a prediction error ε(t,τ)=g(t,τ)−(t,τ). Following the predictive coding model, the prediction error is used to update the state vector via the state network: s(t,τ+1)=fs(s(t,π), ε(t,τ), lt θ^{(s)}(t)). For exploration during reinforcement learning, the same gaussian noise-based exploration strategy as the top level may be used.

During each microstep, the top-level state RNN activity vector is updated using the bottom-level state vector and the top-level location:

$$S ( t , τ + 1 ) = S ( t , τ ) + Fs ( S ( t , τ ) , s ( t , τ + 1 ) , Lt ) \qquad Eqn . 1$$

The top-level action RNN activity vector At is updated in a similar way,

$$A ( t , τ + 1 ) = A ( t , τ ) + Fa ( S ( t , τ + 1 ) , a ( t , τ + 1 ) , Lt ) \qquad Eqn . 2$$

and the process continues. In this embodiment, residual connections are used to assist the learning process. This architecture can be readily extended to more levels by having Fs, Fa be dynamically generated by another parent level, and so on.

The state and action networks are trained separately via different loss functions. The state networks are trained to minimize prediction errors via backpropagation while the action networks are trained to minimize total expected task loss via REINFORCE together with backpropagation (in other applications, such as navigation, the action networks can be trained by other methods such as planning and supervised learning). During training, whenever the state vectors at any given level are passed as input to that level's action network (see FIG. 3a), the gradients for backpropagation are cut off. The goal of the state prediction network is to predict the next state and is task-agnostic. The goal of the action network is to choose effective actions given past states and actions, so that the task loss is minimized.

The prediction error ε_{t,τ} is given by:

$${ϵ}_{t , τ} = {g}_{t , τ} - {\hat{g}}_{t , τ} = G ( {I}_{t}^{( 1 )} , {l}_{t , τ} , m ) - D ( {r}_{t , τ} , {L}_{t} , {l}_{t , τ} ) \qquad Eqn . 3$$

The prediction error loss function is given by:

$${L}_{pred} = {\sum }_{t = 1}^{{T}_{2}} {\sum }_{τ = 1}^{{T}_{1}} {‖ {ϵ}_{t , τ} ‖}_{2}^{2} \qquad Eqn . 4$$

At the end of a macro-step t, the higher level also reconstructs the current reference image I_{ref}⁽¹⁾, downsampled to the size of a lower-level glimpse, using a decoder D_{ref} with inputs Rₜ₊₁ and Lₜ, yielding the loss function L_{ref}=Σₜ₌₁^{T}^{₂}∥I_{ref}⁽¹⁾−D_{ref}(Rₜ₊₁, Lₜ)∥₂². The total loss function for training the state networks at the two levels via backpropagation is given by:

$${L}_{state} = {L}_{pred} + {L}_{ref} \qquad Eqn . 5$$

To apply APCNs to a given task (such as image reconstruction or classification), either the state or action RNN vectors can be provided as input to another neural network trained for the task. Here we use the action vectors. Let Aₒᵤₜ(t, τ)=[Aₜ a_{t,τ}]T be the concatenation of top- and bottom-level action vectors for time step (t, τ). Let Lₜₐₛₖ be the task loss. Using just the final Aₒᵤₜ (as in RAM) for training actions has the shortcoming that the resulting reward function is sparse (the model is evaluated after the final step). A dense, structured reward function (in this example case, a dense loss function) may be used as follows. For each micro-step, the marginal change in loss after the action for that step (i.e., fixating on a new location) has been executed is determined by:

$${υ}_{t , τ} = {L}_{task} ( {A}_{out} ( t , τ - 1 ) ) - {L}_{task} ( {A}_{out} ( t , τ ) ) \qquad Eqn . 6$$

For example, if the task is reconstruction of an image, the reward is positive if the new action (new fixation location) reduced the reconstruction error.

For each macro-step, we compute the marginal change in loss due to the whole macro-step:

$${υ}_{t} = {L}_{task} ( {A}_{out} ( t - 1 , {T}_{1} ) ) - {L}_{task} ( {A}_{out} ( t , {T}_{1} ) ) \qquad Eqn . 7$$

The top layer is trained using the cumulative reward from all future macro-steps, Φₜ=Σᵢ₌ₜ^{T}^{₂} Rᵢ, whereas the bottom layer is trained using the future rewards within each macro-step Φ_{t,τ}=Σ_{j=τ}^{T}^{₁} R_{t,j}. This corresponds to the intuition that micro-actions taken inside different frames of reference should not affect each other in terms of reward.

We use an adjusted version of the baseline-based variance reduction technique. We learn two separate baselines: b_{t,τ}= [symbol] [Φ_{t,τ}] and bₜ= [symbol] [Φₜ] and use the baseline-removed cumulative rewards Φ_{t,τ}−b_{t,τ} and Φₜ−bₜ for training.

The REINFORCE loss is given by:

$${L}_{RL} = - {\sum }_{t = 1}^{{T}_{2}} {\underbrace{( log P ( {L}_{t} \vert {A}_{t} ; {θ}_{L} ) ( {Φ}_{i} - {b}_{l} ) + {\sum }_{τ = 1}^{{T}_{1}} log P ( {l}_{t , τ} \vert {a}_{t , τ} ; {θ}_{l} ) ( {Φ}_{t , τ} - {b}_{t , τ} ) )}}_{Action log - probabilities} \qquad Eqn . 8$$

As mentioned earlier, to allow exploration during training with REINFORCE, the locations at each macro- or micro-step were the location network's output plus Gaussian noise. Therefore, the logarithmic probability terms above reduce to the squared Euclidean distances between the mean and the sampled locations.

The REINFORCE loss is combined with a dense version of the task loss to get the combined loss function for the action networks:

$${L}_{action} = {L}_{RL} + {\underbrace{{\sum }_{t} {\sum }_{τ} {L}_{task} ( {A}_{out} ( t , τ ) ) .}}_{Action sub - system minus location networks} \qquad Eqn . 9$$

For example, if the task is reconstruction, the second term in the combined loss allows minimization of the reconstruction error at every time step. Overall, the combined loss function increases the performance of the intermediate action vectors from step to step in the context of the task, producing more interpretable results. To encourage the action networks to produce locations within image boundaries, locations were regularized using a soft l₂ penalty.

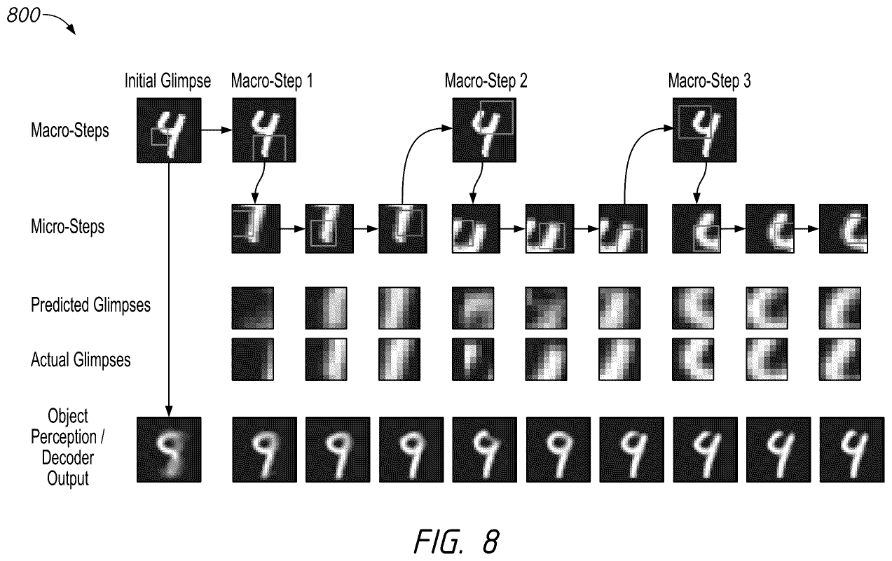

FIG. 8 is a sequence of images representing a sequence of operations of an example APCN to perform visual perception of character according to some embodiments of the present disclosure. The images of FIG. 8 may represent sequential steps of the operation of an APCN such as the APCN 700 of FIG. 7, for example as it follows method 500 of FIG. 5. In the example implementation of FIG. 8, three macrosteps are performed, and for each macrostep 3 microsteps are performed (e.g., T1=T2=3).

The diagram is organized into rows, with the top row representing each macrostep, showing the input image as well as a box which represents which region is selected for examination. The next row represents microsteps in a similar fashion, showing the selected region for that macrostep and then boxes to represent the sub-regions selected in that region. The next two rows represent the predicted and actual glimpses, which may be used to generate an error for feedback purposes as described above. The final row represents an output of the APCN, showing the overall determined perception of the image. The columns represent different steps, with each of 3 macrosteps having three microsteps before the next macrostep. The final image of the bottom row represents an output of the APCN, the reconstruction of the object in the original image (pictured along the top row) based on the glimpses of the sub-regions shown in the microsteps.

The diagram 800 shows an initial glimpse which represents an initialization of the higher-level state and action vectors (e.g., S(t=0) and A(t=0)). The initial glimpse may, in some embodiments be randomly chosen. As may be seen, at the initial glimpse, the perception of the APCN is of an incorrect character, a ‘9’ instead of the ‘4’ in the image.

At the first macro-step, a region is chosen and investigated over three microsteps. The selected region at the first macrostep is the downward stroke of the ‘4’, which is useful to confirming the shape of the anticipated character. At the second macro-step, the selected region is a at the top right corner, a region expected to help differentiate the expected character from the other possible characters. Over the course of those microsteps, the perception of the network begins to shift towards a ‘4’, by opening up the top of the perceived figure, since that is the investigated region. By the third macrostep the correct perception of the figure as a ‘4’ has become relatively stable. At the end of the macrosteps, the perception/reconstruction of the overall original object is relatively accurate.

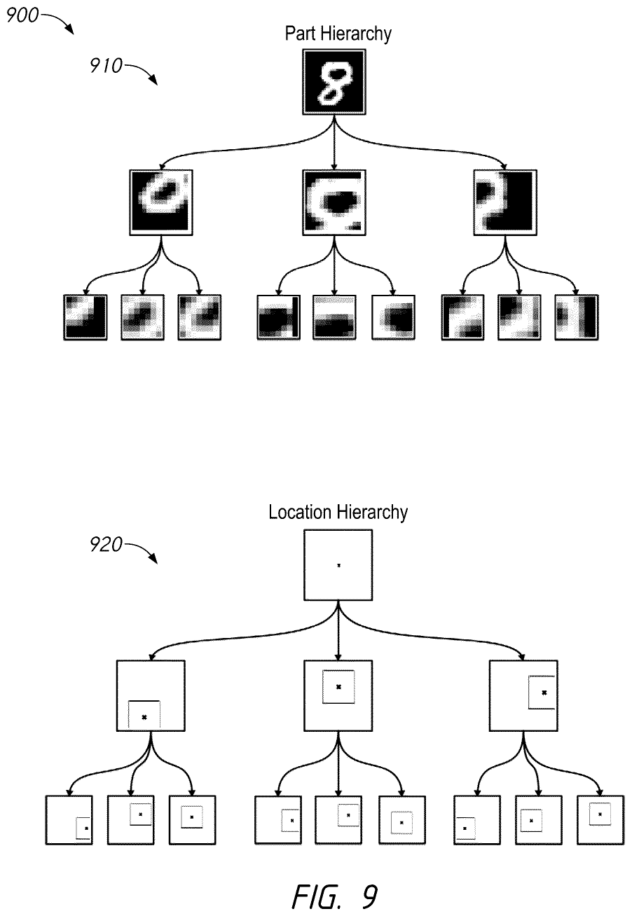

FIG. 9 shows block diagrams showing an example hierarchy of a parse tree which may be used by an APCN performing visual perception of a written character according to some embodiments of the present disclosure. FIG. 9 shows a part hierarchy 910 and a location hierarchy 920. The part and location hierarchies 910 and 920 may represent the operation of an APCN such as the APCN 700 of FIG. 7 which has been trained to recognize written characters (e.g., similar to the example operation shown in FIG. 8). FIG. 9 organizes the operation into a whole input image (top row), the regions selected during macrosteps (second row) and the sub-regions selected during microsteps (third row). The part hierarchy 910 shows the information in the image which is selected, while the location hierarchy 920 may represent the selected regions/subregions by showing the location and size of box which is used to select the region/subregion. The part hierarchy 910 may represent the operation of state vectors (e.g., S and s) while the location hierarchy 920 may represent the operation of action vectors (e.g., A and a).

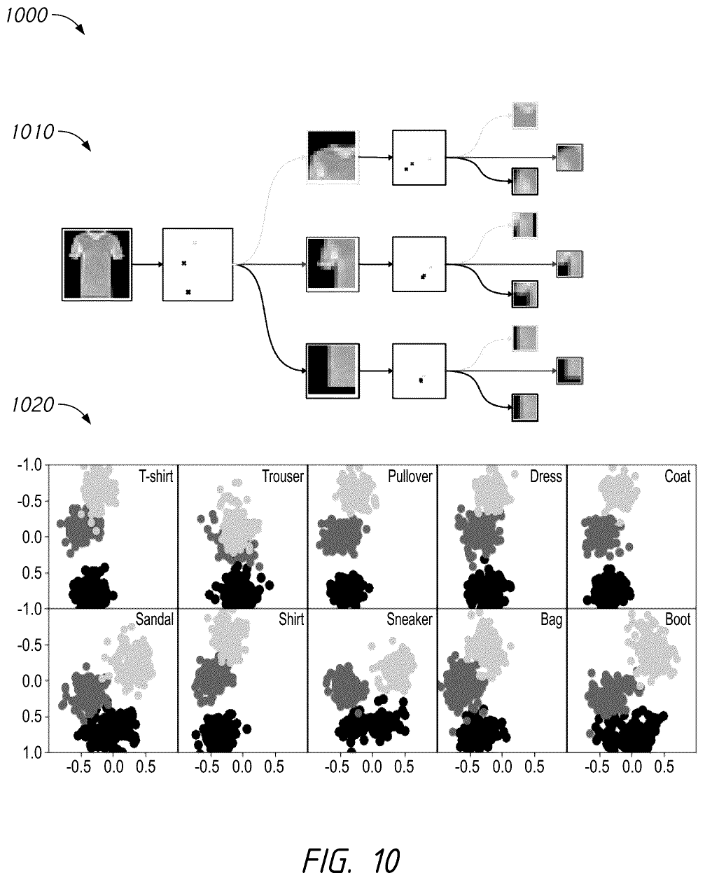

FIG. 10 shows block diagrams showing an example hierarchy of a parse tree which may be used by an APCN performing visual perception of a garment according to some embodiments of the present disclosure. FIG. 10 includes a hierarchy 1010, which may be thematically similar to a combination of the parse trees 910 and 920 of FIG. 9. In the hierarchy 1010, the state is represented as images, with a horizontal arrow to the diagram of the selected regions or sub-regions, which then split horizontally into microsteps. Like FIG. 9, the operation of FIG. 10 may be performed by an APCN such as 700 of FIG. 7, however the APCN of FIG. 10 is trained for a different task (recognition of garments rather than characters). In the case of the trained APCN of FIG. 10, the output of the APCN may be a classification of the type of object (in this case a type of garment) pictured in the image.

As may be seen by comparing the locations selected in FIGS. 9 and 10, the trained networks may learn that different regions and subregions are to be examined based on the task. Diagram 1020 shows the top-level part locations selected by the trained APCN for all classes of garment. Note the differences in the network's action strategies between vertically symmetric items and footwear. The locations are normalized to the [1, 1] range, with 1 being the left-most (or top) and 1 the right-most (or bottom) edges of the image.

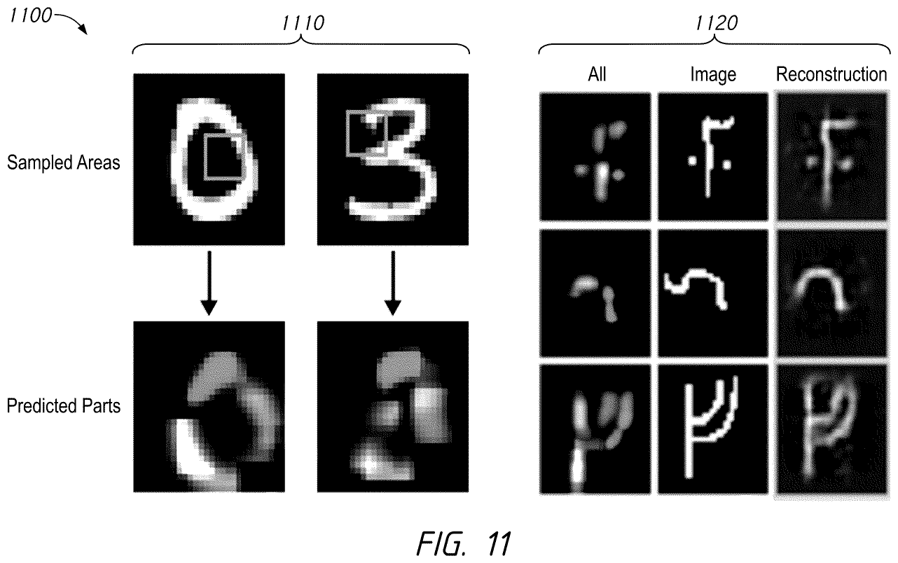

FIG. 11 shows images which represent an example of how the learning of a trained APCN may be applied to novel information. FIG. 11 shows an example of ‘transfer learning’ where an APCN which was trained on a set of information is shown new data which it was not trained on, but which shares similarities with the training. For example, FIG. 11 shows the operation of an APCN, such as 700 of FIG. 7, which was trained on a data set of handwritten characters (e.g., similar to FIGS. 9 and 10).

The diagrams 1110 show two example input images, which show the characters 0 and 3 respectively (top row) along with a selected initial glimpse. Both the characters in the diagram 1010 represent characters which were used to train the APCN. Based on that selected initial glimpse, the APCN generates an initial ‘best guess’ of the parts of the object (bottom row). As may be seen, the trained model is reasonably accurate at predicting the identity of the pieces of a character based on its training.

That same trained APCN is applied to characters it has not previously in the diagram 1120. The middle column of the diagram 1120 shows the actual image. The left column shows the APCN's best guess as to the parts of the image based on that initial glimpse, and the right column shows the reconstruction of the initial image performed by the APCN. As may be seen, based on training about which portions of a written character may be useful, the trained APCN may begin to reconstruct characters it has never seen before, based on generating lower-level networks to ‘program’ itself from the trained hypernetworks.

### Example 2—Hierarchical Planning

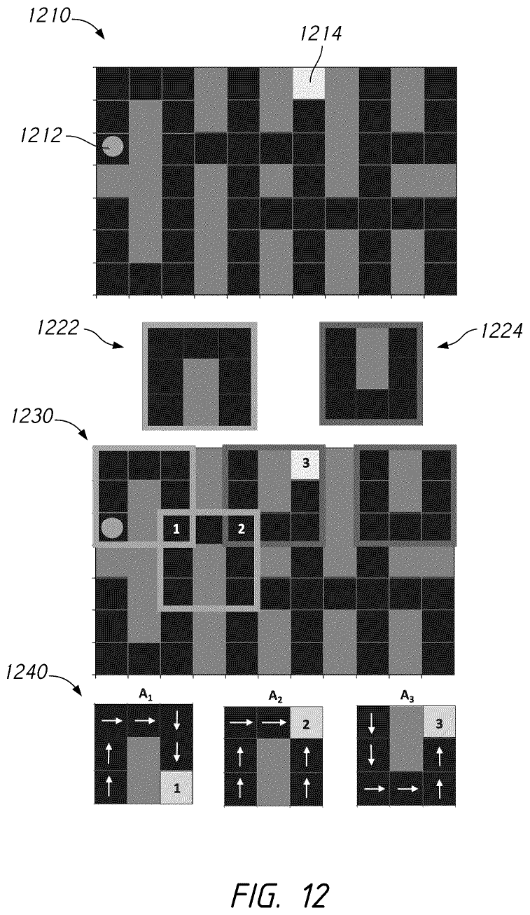

In a hierarchical planning APCN, the APCN may examine an environment in order to perform planning to accomplish a task. For example, FIGS. 12-14 show an example APCN, such as the APCN 300 of FIG. 3, which has been trained to use hierarchical planning to develop a set of instructions which move an agent from a starting location (or starting state) to a goal in an object, environment, or problem space. For example, the APCN may move the agent from a starting location to a goal in order to navigate a “maze.” As used herein the term “maze” may be used to refer generically to any environment which requires navigation from an initial location to an end location (e.g., a straight path may not be possible due to walls or obstacles). In this example the maze may be represented as a scalable ‘multi-room’ which is composed of repeating sub-structures. The goal of the problem may be to navigate an agent from any starting location to any goal location in the maze. In a trained APCN, the problem of solving the maze may be broken down into similar sub-problems (e.g., sub-regions of the maze) and the sub-region is recognized as a previously solved maze, then the previously known solution may be applied. The input to the APCN may be information about the environment (e.g., a digital representation of the geometry of the maze, in this case which blocks are ‘solid’ vs. which blocks can be moved through in a grid) as well as the location of the start and end within that environment (e.g., as represented by coordinates). The state vector may be initialized with some or all of this information. The output of the APCN may be a set of instructions which navigate from the start to the end.

In a manner analogous to the visual perception of Example 1, in the hierarchical planning of Example 2, the higher level of an APCN may identify different regions of the maze, and then generate lower-level networks which develop solutions to those identified regions as the lower-level action vectors. By breaking down the maze into similar parts, a solution may be efficiently developed to navigate an agent out of the maze. For example, based on how the higher-level network sub-divided the environment, the lower-level action vectors (which contain instructions for navigating the individual sub-parts of the environment) may be organized into an overall solution to the maze. Since the sub-parts may be similar to each other and since previously solved sub-parts may share a same solution, the use of the APCN may represent an efficient way in which to develop a set of instructions to navigate the maze.

FIG. 12 shows a set of diagrams representing an example maze and how an APCN may apply hierarchical planning to it according to some embodiments of the present disclosure. The diagram 1210 shows an initial state of the maze, with walls and open paths. Also shown are an agent 1212 and a goal 1214. The APCN is trained with the goal of moving the agent 1212 to the goal 1214 in the most efficient manner (e.g., the fewest moves possible). Diagrams 1222 and 1224 are sub-units of the maze. The maze 1210 may be composed of a number of repeating units, such as 1222 and 1224. The diagram 1230 highlights where these sub-units are located in the original maze 1210. The three diagrams 1240 show different examples the APCN may apply by using lower-level networks to solve the sub-divided maze.

For example, the sub-components 1222 and 1224 may represent part of the higher-level states in the APCN and are defined by state embedding vectors (say, S1 and S2), which can be trained to generate, via the hypernet Hs (e.g., 114 of FIG. 1), the lower-level transition functions fs for rooms R1 and R2 1222 and 1224, respectively. Next, similar to how the APCN model of Example 1 was able to reconstruct an image using top-level action embedding vectors to generate policies and actions (locations) to compose parts using strokes, the APCN model of Example 2 can compute top-level action embedding vectors Ai (option vectors) for the multi-rooms world that generate, via hypernet Ha (e.g., 124 of FIG. 1), bottom-level policies fa that produce primitive actions (N, E, S, W) to reach a goal i encoded by Ai (note that we use the subscript i for A here in the rest of the explanation of Example 2 to denote a particular goal rather than time).

The diagram 1240 illustrates the bottom-level policies for three such action-embedding vectors A1, A2, and A3, which generate policies for reaching goal locations 1, 2, and 3, respectively. Note that the Ai are defined with respect to higher-level state S1 or S2 corresponding to room type R1 or R2. Defining these policies to operate within the local reference frame of the higher-level state S1 or S2 (regardless of global location in the building) confers the APCN model with enormous flexibility because the same policy can be reused at multiple locations to solve local tasks (here, reach subgoals within R1 or R2).

For example, to solve the navigation problem in the diagram 1210, the APCN model only needs to plan and execute 3 higher-level actions or options: A1 followed by A2 followed by A3, compared to planning a sequence of 12 lower-level actions to reach the same goal. Finally, since the Ai embedding space of options is continuous, the APCN model offers an unprecedented opportunity to exploit properties of this embedding space (such as smoothness) to interpolate or extrapolate to create and explore new options for transfer learning.

In this example, the higher-level states capture 3×3 local reference frames in the grid of the maze. The higher-level states are defined by an embedding vector generating the transition function for “room type” R1 or R2, along with the location for this local reference frame in the global frame of the maze. The lower-level action network fa is trained to map a higher-level action embedding vector Ai to a lower-level policy that navigates the agent 1212 to a particular goal location i within R1 or R2.

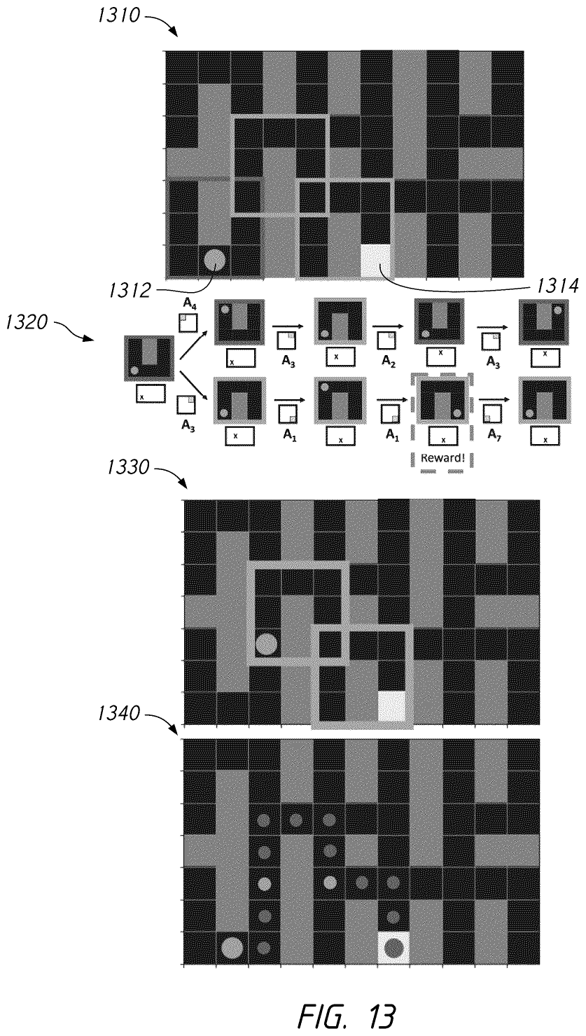

FIG. 13 shows a set of diagrams representing an example maze and how an APCN may apply hierarchical planning to it according to some embodiments of the present disclosure. The first diagram 1310 shows the same maze as the diagram 1210 of FIG. 12. However, in the example of FIG. 13, the agent 1312 and the goal 1314 have different locations. Boxes are shown superimposed on the maze to represent the room types R1 and R2 1222 and 1224 previously described with respect to FIG. 12.

The diagram 1320 shows eight embedding vectors A1, . . . , A8 which were trained, using REINFORCE-based RL to generate via the hypernet Ha eight lower-level policies to navigate to each of the four corners of room types R1 and R2. The higher-level state network Fs was trained to predict the next higher-level state (decoded as an image of room type R1 or R2, plus its location) given the current higher-level state and higher-level action.

The trained higher-level state network Fs was used for planning at each step a sequence of four higher-level actions using “random-sampling shooting” model-predictive control (MPC): random state-action trajectories of length 4 were generated using Fs by starting from the current state and picking one of the four random actions Ai for each next state; the action sequence with the highest total reward was selected, and its first action was executed. The planning algorithm MPC used here can be substituted by any other planning algorithm in other example implementations.

We compared the two-level APCN model with both a heuristic lower-level-only planning algorithm and a REINFORCE-based RL algorithm using primitive states and actions. The task involved navigating to a randomly selected goal location in a building environment (as in FIG. 13), with the goal location changing after some number of episodes.

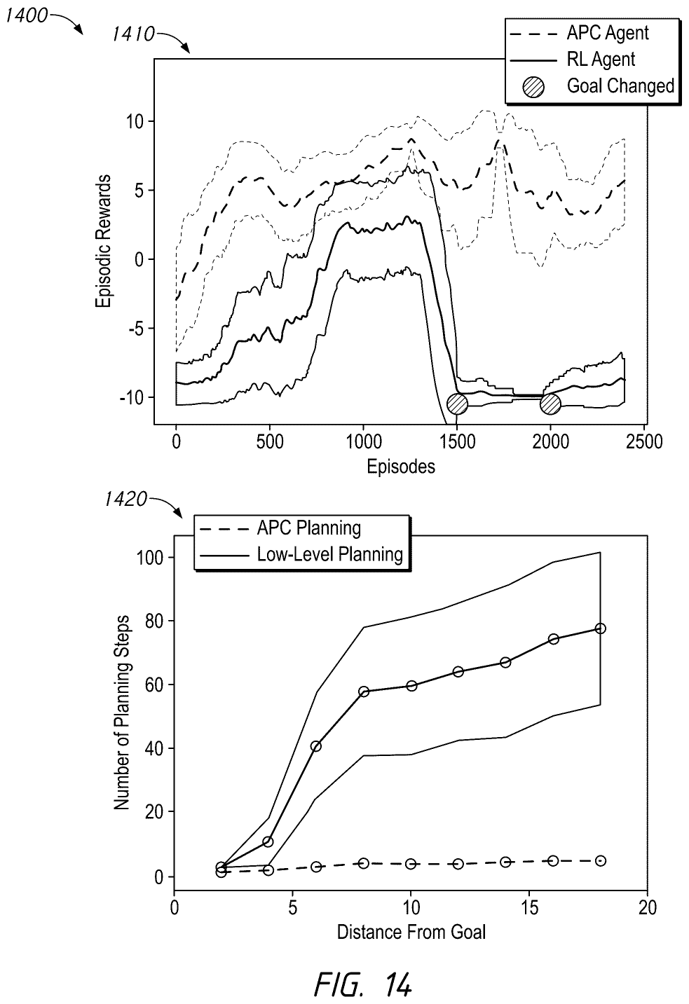

FIG. 14 shows graphs comparing the performance of an APCN to other types of machine learning in solving the maze of FIG. 13. The graph 1410 shows how the APCN model, after an initial period spent on learning the hypernet Ha to generate the lower-level options, is able to cope with goal changes and successfully navigate to each new goal by sequencing high-level actions (10 reward for goal; 0.1 per primitive action). The RL algorithm experiences a drop in performance after a goal change and does not recover even after 500 episodes.

The graph 1420 demonstrates the efficacy of APC's higher-level planning compared to lower-level planning (MPC using random sequences of four primitive future actions; Euclidean distance heuristic): the average number of planning steps to reach the goal increases dramatically for larger distances from the goal for lower-level compared to higher-level planning.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method of generating and using an active predictive coding network (APCN) implemented on at least one computing device, the method comprising:
inputting a representation of an object, environment or problem to the APCN and initializing a higher-level state vector based on a first frame of reference which represents all or a part of the object, environment or problem;
iteratively performing one or more macrosteps to sub-divide the first frame of reference into portions by:
updating the higher-level state vector using a higher-level state neural network trained to determine a current state of the first frame of reference;
updating a higher-level action vector with a higher-level action neural network trained to select a second frame of reference which is a selected portion of the first frame of reference, wherein the higher-level action vector indicates the selected second frame of reference;
generating or updating a lower-level state neural network with a first trained hypernetwork by providing the updated higher-level state vector as an input to the first trained hypernetwork;
generating or updating a lower-level action neural network with a second trained hypernetwork by providing the updated higher-level action vector as an input to the second trained hypernetwork; and
iteratively performing one or more microsteps on the selected second frame of reference, wherein performing each of the microsteps includes:
updating a lower-level state vector with the lower-level state neural network, wherein the lower-level state neural network is trained to determine a current state of the selected second frame of reference; and
updating a lower-level action vector with the lower-level action neural network, wherein the lower-level action neural network is trained to analyze or perform an action with respect to the current state of the selected second frame of reference,
wherein the APCN assembles a solution with respect to the first frame of reference based on solutions determined with respect to the one or more selected second frames of reference.

2. The method of claim 1, wherein the APCN is trained to receive an image which includes one or more objects as an input and output a classification or reconstruction of the object based on the updated higher-level state vector at the end of the one or more macrosteps,
and wherein the APCN learns a part-whole hierarchy of the one or more objects.

3. The method of claim 2, wherein the higher-level state vector represents the APCN's current estimation or reconstruction of the object,
wherein the higher-level action neural network is trained to select the second frame of reference by selecting a portion of the image including a selected portion of the object,
wherein the lower-level state vector represents the APCN's current estimate of the selected portion of the image,
wherein the lower-level action neural network is trained to select sub-regions within the second frame of reference used to update the estimation of the selected portion, and
wherein the higher-level state vector is updated based on the lower-level state vector at the end of performing the one or more microsteps.

4. The method of claim 2, further comprising:
extracting a portion of the image with a glimpse sensor based on a location contained in the higher-level action vector; and
updating the higher-level state vector based, in part, on the extracted portion.

5. The method of claim 1, wherein the APCN is trained to:
receive an input which includes information about an environment or problem, a starting location or state of an agent, and a goal state; and
output a set of instructions which navigate the agent through the environment or problem to the goal state based on the higher-level action vector.

6. The method of claim 5,
wherein the higher-level state vector represents the environment or problem, starting location or starting state, and the goal,
wherein the higher-level action neural network is trained to identify repeating sub-units of the environment or problem,
wherein the lower-level state vector represents one of the identified sub-units,
wherein the lower-level action vector represents a path for an agent to take through the portion of the environment or problem space, and
wherein an overall path through the environment or problem space is constructed from the paths through the identified sub-units developed from the lower-level action vectors.

7. The method of claim 1, further comprising performing a fixed number of microsteps before performing the next macrostep.

8. The method of claim 1, further comprising performing microsteps until a termination condition is reached before performing the next macrostep.

9. The method of claim 1, further comprising:
generating weights and biases of or updating, via embedding inputs, the lower-level state neural network with the first hypernetwork based on the updated higher-level state vector; and
generating weights and biases of or updating, via embedding inputs, the lower-level action neural network with the second hypernetwork based on the updated higher-level action vector.

10. The method of claim 1, wherein the higher-level state neural network, the lower-level state neural network, the higher-level action neural network and the lower-level action neural network are recurrent neural networks (RNNs) or transformer networks.

11. The method of claim 1, further comprising updating at least one of the higher-level state vector or the higher-level action vector based on the updated lower-level state vector, the updated lower-level state vector, or combinations thereof at the end of iteratively performing the one or more microsteps.

12. The method of claim 11, further comprising:
generating a predicted input with a decoder based on the lower level state vector and the lower-level action vector;
determining an actual input based on the lower-level action vector;
comparing the predicted input with the actual input to generate an error; and
updating the higher-level state vector based on the error.

13. The method of claim 1, further comprising:
updating the higher-level state vector by providing a previous higher-level state vector and a previous higher-level action vector as inputs to the higher-level state neural network; and
updating the higher-level action vector by providing the updated higher-level state vector and the previous higher-level action vector as inputs to the higher-level action neural network.

14. The method of claim 1, further comprising:
initializing the lower-level state vector with an initialization network based on the higher-level state vector at a first of the microsteps; and
initializing the lower-level action vector with the lower-level action network based on the initialized lower-level state vector at the first of the microsteps.

15. An apparatus comprising:
a processor;
non-transitory media configured to store instructions which, when executed by the processor, cause the apparatus to:
initialize a higher-level state vector based on a first frame of reference which represents all or a part of an object or environment;
iteratively perform one or more macrosteps to sub-divide the first frame of reference into portions by:
updating the higher-level state vector using a higher-level state neural network trained to determine a current state of the first frame of reference;
updating a higher-level action vector with a higher-level action neural network trained to select a second frame of reference which is a selected portion of the first frame of reference, wherein the higher-level action vector indicates the selected second frame of reference;
generating or updating a lower-level state neural network with a first trained hypernetwork by providing the updated higher-level state vector as an input to the first trained hypernetwork;
generating or updating a lower-level action neural network with a second trained hypernetwork by providing the updated higher-level action vector as an input to the second trained hypernetwork; and
iteratively perform one or more microsteps on the selected second frame of reference, wherein performing each of the microsteps includes:
updating a lower-level state vector with the lower-level state neural network, wherein the lower-level state neural network is trained to determine a current state of the selected second frame of reference; and
updating a lower-level action vector with the lower-level action neural network, wherein the lower-level action neural network is trained to analyze or perform an action with respect to the current state of the selected second frame of reference.

16. The apparatus of claim 15, wherein the instructions further cause the apparatus to, as part of the macrostep, update the higher-level state vector based on the lower-level state vector, update the higher-level action vector based on the lower-level action vector, or combinations thereof.

17. The apparatus of claim 15, wherein the instructions further cause the apparatus to:
initialize the lower-level state vector based on the higher-level state vector at a first of the at least one microsteps; and
initialize the lower-level action vector based on the initialized lower-level state vector at the first of the at least one microsteps.

18. The apparatus of claim 15, wherein the instructions further cause the apparatus to:
train a state hypernetwork based, in part, on a training data set or data generated from interactions with the environment or problem; and
train an action hypernetwork based, in part, on a training data set or data generated from interactions with the environment or problem.

19. The apparatus of claim 18, wherein the instructions further cause the apparatus to:
generate or update the lower-level state network with the state hypernetwork; and
generate or update the lower-level action network with the action hypernetwork.

20. A method of iteratively determining solutions with respect to an object, environment or problem using an active predictive coding network (APCN) implemented on at least one computing system, the method comprising:
determining a current state of the object, environment or problem based on a previous state and a previous action using a higher-level state neural network of the APCN;
determining a current action for the object, environment or problem based on the previous action and the current state using a higher-level action neural network of the APCN;
selecting a portion or part of the object, environment or problem based on the current action to sub-divide the object, environment or problem space;
generating or updating a lower-level state neural network based on the current state and generating or updating a lower-level action neural network based on the higher-level action wherein the lower-level state neural network and the lower-level action neural network operate on the selected portion; and
iteratively updating a lower-level state and a lower-level action using the lower-level state neural network and the lower-level action neural network respectively, comprising:
determining the current lower-level state of the selected part or portion based on a previous lower-level state and a previous lower-level action using the lower-level state neural network;
determining a current lower-level action for the selected part or portion based on the current lower-level state of the selected one of the one or more parts or portions and the previous lower-level action of the selected one of the one or more part or portions using the lower-level action network; and
updating the higher-level state and the higher-level action based on the iteratively updated lower-level state and the iteratively updated lower-level action.

21. The method of claim 20, wherein the higher-level state neural network and the higher-level action neural network generate or modulate the lower-level state network and the lower-level action network respectively using hypernetworks or an embedding network.

22. The method of claim 20, wherein the object is an image and the state represents integrated scene information provided by the lower-level state neural network and the lower-level action neural network and the action represents which portion of the object should be selected next for examination by the lower-level state neural network and the lower-level action neural network.

23. The method of claim 20, wherein the object represents an environment or problem and the action represents a set of steps to move an agent towards a goal state in the environment or problem space, and wherein the lower level generates a lower-level state which represents a sub-unit of the environment or problem and a lower-level action which represents a path through the sub-unit.

24. The method of claim 20, wherein the lower-level state function and the lower-level action function execute for a fixed number of steps or until a lower-level goal is reached.
